(19) United States
(12) Patent Application Publication
(10) Pub. No.: US 2018/0322440 A1
(43) Pub. Date: Nov. 8, 2018

(54) METHOD AND DEVICE FOR PROMPTING RELATIONSHIP AND TASK DURING COMMUNICATION

(71) Applicant: Alibaba Group Holding Limited, Grand Cayman (KY)

(72) Inventors: Qing Ren, Hangzhou (CN); Hang Chen, Zhejiang (CN)

(21) Appl. No.: 16/034,879

(22) Filed: Jul. 13, 2018

Related U.S. Application Data
(63) Continuation of application No. PCT/CN2017/070357, filed on Jan. 6, 2017.

(30) Foreign Application Priority Data
Jan. 14, 2016 (CN) 201610024573.7

(51) Int. Cl. G06Q 10/06; G06Q 10/10; G06F 9/54; G06F 17/30

(52) U.S. Cl. CPC G06Q 10/063114; G06Q 10/103; G06F 17/30991; G06F 17/30604; G06F 17/30528; G06F 9/546

(57) ABSTRACT

A relationship prompting method may include detecting a communication event; determining relationship data between a requester user and a responder user or an associated user corresponding to the responder user of the communication event; and pushing the relationship data to the responder user such that the relationship data is displayed in an associated device of the responder user. By using the technical solution of the present disclosure, a relationship prompt is provided for a user in a communication process, helping the user infer the communication intent of the other party and helping improve the communication efficiency.

### CROSS REFERENCE TO RELATED PATENT APPLICATIONS

This application claims priority to and is a continuation of PCT Patent Application No. PCT/CN2017/070357, filed on 6 Jan. 2017, which claims priority to Chinese Patent Application No. 201610024573.7 filed on 14 Jan. 2016 and entitled “METHOD AND DEVICE FOR PROMPTING RELATIONSHIP AND TASK DURING COMMUNICATION”, which are incorporated herein by reference in their entirety.

### TECHNICAL FIELD

The present disclosure relates to the field of communication technologies, and, more particularly, to relationship and task prompting methods and apparatuses in a communication process.

### BACKGROUND

Communication initiated by a user A to a user B generally carries a corresponding communication intent, which may obviously help the two communicate better if user B may quickly understand the communication intent of user A.

However, in the conventional techniques, user B cannot directly determine the communication intent of user A or may even forget or not know identity information of user A unless user A makes a description proactively. Therefore, there are problems of long communication times and low efficiency in a communication process in the conventional techniques.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides relationship and task prompting methods and apparatuses in a communication process, which may provide a relationship prompt for a user in the communication process, thus helping the user infer the communication intent of the other party and helping improve the communication efficiency.

The present disclosure provides the following technical solutions:

According to a first aspect of the present disclosure, a relationship prompting method in a communication process is provided, including:

detecting a communication event;

determining relationship data between a requester user and a responder user or an associated user corresponding to the responder user of the communication event; and

pushing the relationship data to the responder user such that the relationship data is displayed in an associated device of the responder user.

According to a second aspect of the present disclosure, a relationship prompting apparatus in a communication process is provided, including:

a detecting unit configured to detect a communication event;

a determining unit configured to determine relationship data between a requester user and a responder user or an associated user corresponding to the responder user of the communication event; and

a prompting unit configured to push the relationship data to the responder user such that the relationship data is displayed in an associated device of the responder user.

According to a third aspect of the present disclosure, a relationship prompting method in a communication process is provided, including:

detecting a communication event;

determining an uncompleted task related to a requester user and a responder user of the communication event; and

pushing the uncompleted task to at least one of the requester user and the responder user such that the uncompleted task is displayed in an associated device of the corresponding user.

According to a fourth aspect of the present disclosure, a relationship prompting apparatus in a communication process is provided, including:

a detecting unit configured to detect a communication event;

a determining unit configured to determine an uncompleted task related to a requester user and a responder user of the communication event; and

a pushing unit configured to push the uncompleted task to at least one of the requester user and the responder user such that the uncompleted task is displayed in an associated device of the corresponding user.

As shown the foregoing technical solutions, the present disclosure pushes the relationship data to an associated device of the responder user and displays the relationship data in the associated device, such that the responder user may know identity information and the communication intent of the requester user in time and get prepared accordingly, and the requester user does not need to describe and explain the uncompleted task, thus shortening the communication time and improving the communication efficiency.

### BRIEF DESCRIPTION OF THE DRAWINGS

To describe the technical solutions in the example embodiments of the present disclosure, the following briefly introduces the accompanying drawings describing the example embodiments. Apparently, the accompanying drawings described in the following merely represent some example embodiments described in the present disclosure, and those of ordinary skill in the art may still derive other drawings from these accompanying drawings without creative efforts.

FIG. 1 is a flowchart of a relationship prompting method in a communication process according to an example embodiment of the present disclosure;

FIG. 2A is a schematic diagram of a communication process according to an example embodiment of the present disclosure;

FIG. 2B is a schematic diagram of another communication process according to an example embodiment of the present disclosure;

FIG. 3 is a schematic diagram of implementing a relationship prompt in a communication process according to an example embodiment of the present disclosure;

FIG. 4 is a schematic diagram of a task prompt in a communication process according to an example embodiment of the present disclosure;

FIG. 5 to FIG. 9 are schematic diagrams of a communication interface of a terminal of a responder user according to an example embodiment of the present disclosure;

FIG. 10 is a schematic diagram of a task prompt in another communication process according to an example embodiment of the present disclosure;

FIG. 11 is a schematic structural diagram of an electronic device according to an example embodiment of the present disclosure;

FIG. 12 is a block diagram of a relationship prompting apparatus in a communication process according to an example embodiment of the present disclosure;

FIG. 13 is a flowchart of a task prompting method in a communication process according to an example embodiment of the present disclosure;

FIG. 14 is a schematic diagram of implementing a task prompt in a communication process according to an example embodiment of the present disclosure;

FIG. 15 is a flowchart of a task prompting method in another communication process according to an example embodiment of the present disclosure;

FIG. 16A is a schematic diagram of an interface for historical communication data according to an example embodiment of the present disclosure;

FIG. 16B is a schematic diagram of another interface for historical communication data according to an example embodiment of the present disclosure;

FIG. 17 is a schematic diagram of a task prompt in a communication process according to an example embodiment of the present disclosure;

FIG. 18A is a schematic diagram of a call interface of a terminal of a requester user according to an example embodiment of the present disclosure;

FIG. 18B is a schematic diagram of a call interface of a terminal of a responder user according to an example embodiment of the present disclosure;

FIG. 19 is a schematic diagram of an instant messaging interface of a responder user according to an example embodiment of the present disclosure;

FIG. 20 is a schematic diagram of a task prompt in another communication process according to an example embodiment of the present disclosure;

FIG. 21 is a schematic structural diagram of an electronic device according to an example embodiment of the present disclosure;

FIG. 22 is a block diagram of a task prompting apparatus in a communication process according to an example embodiment of the present disclosure; and

FIG. 23 to FIG. 24 are schematic diagrams of a communication interface of a terminal of a responder user according to an example embodiment of the present disclosure.

### DETAILED DESCRIPTION

In a call interface of a terminal, only a name of the initiator user of the call may be viewed. However, as the responder user may have multiple contacts having the same name, or the responder user is unfamiliar with the initiator user, or the like, the responder user cannot determine a relationship between himself/herself and the initiator user and thus cannot infer the real intent of this call. The responder user must wait for the initiator user to describe the intent after the call is put through.

Similarly, in various other communication processes such as instant messaging and email, when the initiator user first sends a greeting such as “Hi”, the responder user still cannot determine a relationship between himself/herself and the initiator user, and still cannot infer the real intent of the initiator user unless the initiator user actively describes the intent.

Therefore, in the communication process of the conventional techniques, the responder user cannot determine the relationship between himself/herself and the initiator user and thus cannot infer the real intent of the initiator user, resulting in problems such as a long time consumed and low efficiency in the communication process.

Therefore, the present disclosure may solve the above technical problems in the conventional techniques by implementing a relationship prompt in a communication process. The following embodiments are provided to further describe the present disclosure.

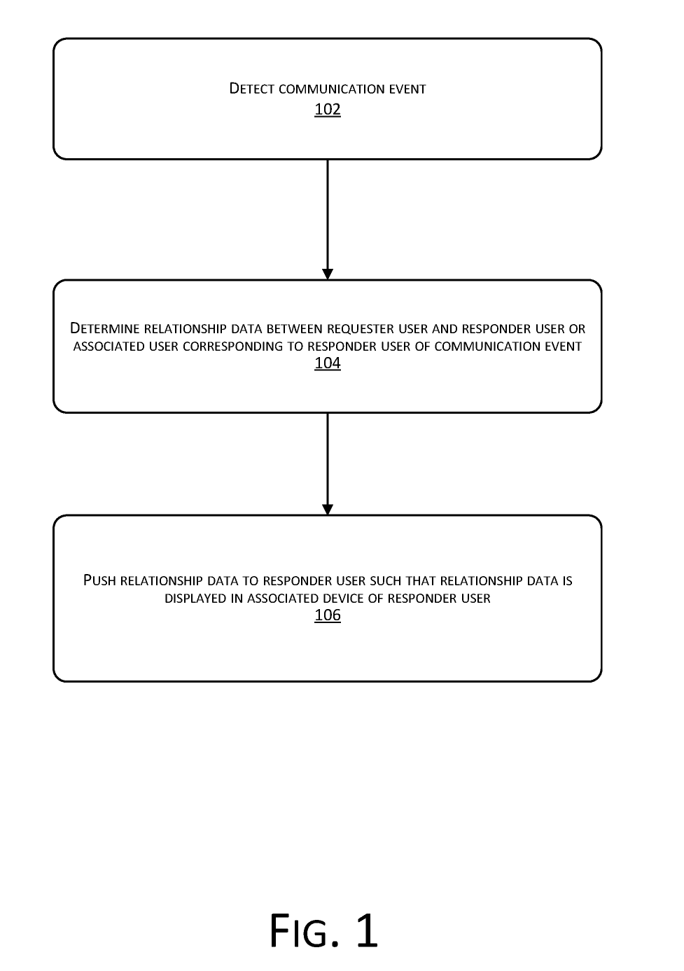

FIG. 1 is a flowchart of a relationship prompting method in a communication process according to an example embodiment of the present disclosure. As shown in FIG. 1, the method is applied to a server, and may include the following steps:

Step 102: A communication event is detected.

Step 104: Relationship data between a requester user and a responder user or an associated user corresponding to the responder user of the communication event is determined.

Step 106: The relationship data is pushed to the responder user to be displayed in an associated device of the responder user.

Various features involved in the above embodiment are described in detail below with reference to the accompanying drawings.

1. Client Terminal Application and Communication Platform

In the present disclosure, the requester user may use a client terminal application in a terminal of his/her own to establish a communication event between the requester user and a responder user through a communication platform borne by the server. The client terminal application may correspond to a communication type in a one-to-one manner. For example, when the communication type is call, instant messaging, email, and the like, multiple client terminal applications each corresponding to one of the communication types may be installed in the terminal to implement a communication event of a corresponding type respectively. Alternatively, the client terminal application may merge various communication types, and in this case, only such a client terminal application may be installed in the terminal to implement multiple types of communication events.

As an example embodiment, the client terminal application may be an instant messaging application, for example, an Enterprise Instant Messaging (EIM) application such as Ding Talk. By merging various communication types, Ding Talk may implement various types of communication events such as call, instant messaging, email, timed message pushing (e.g., a “DING message”), and the like. Therefore, the platform borne by the server may be referred to as a “Ding Talk unified communication platform” that may uniformly support various types of communication events.

To facilitate description, the following embodiments all use “Ding Talk” and “Ding Talk unified communication platform” as examples to describe the technical solution of the present disclosure in further details.

2. Establish a Communication Event

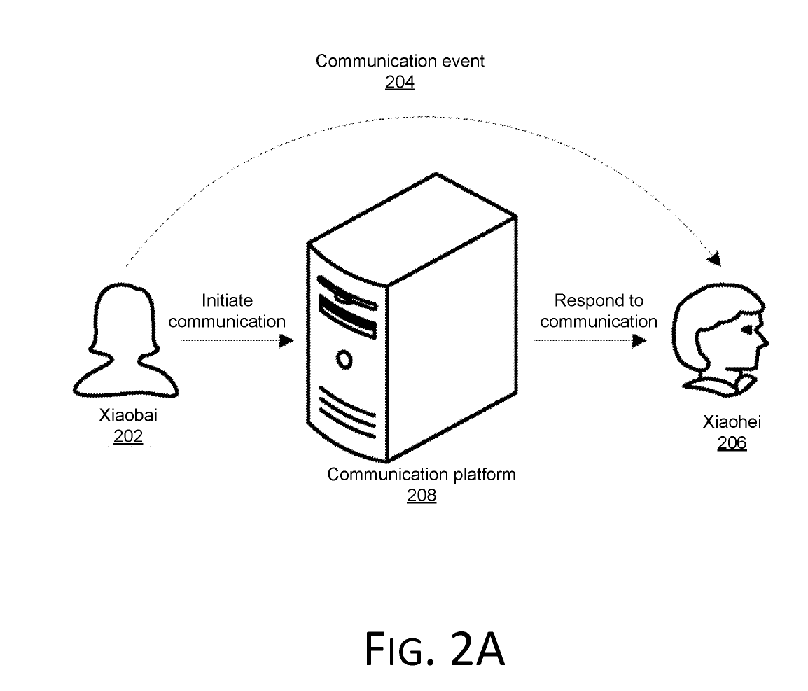

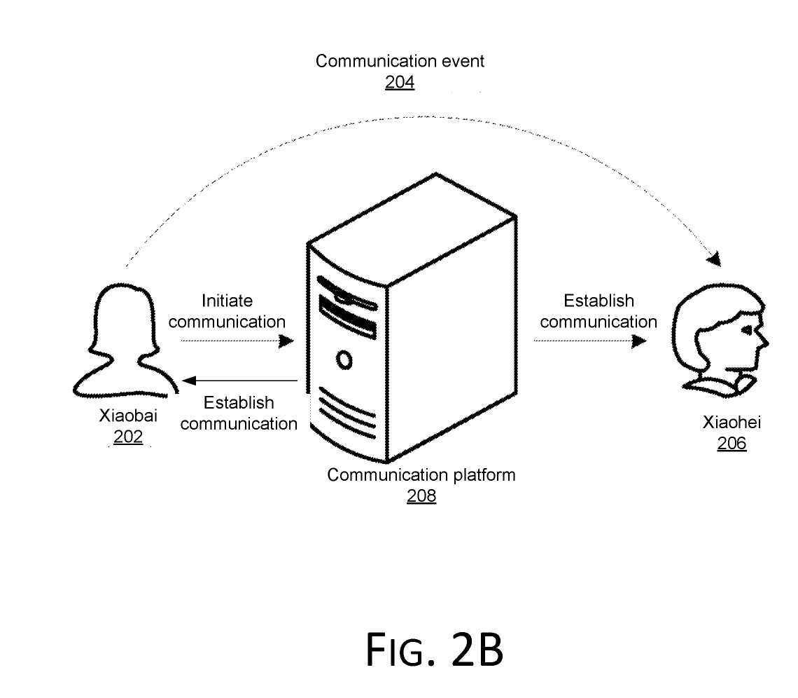

In FIGS. 2A and 2B, assume that a user “Xiaobai” 202 initiates a communication event 204 to a user “Xiaohei” 206, that is, the user “Xiaobai” 202 is the initiator user and a user “Xiaohei” 206 is the responder user. The following scenarios may exist for the process of creating the communication event:

1) In one case, as shown in FIG. 2A, assuming that the user “Xiaobai” 202 initiates a communication request for the user “Xiaohei” 206 via a communication platform 208 such as a Ding Talk unified communication platform, then the Ding Talk unified communication platform directly establishes a corresponding communication event between the user “Xiaobai” 202 and the user “Xiaohei” 206 based on the communication request initiated by the user “Xiaobai” 202, wherein the user “Xiaobai”202 is the initiator user of the communication event 204 and the user “Xiaohei” 206 is the responder user of the communication event 204.

For example, assuming that the user “Xiaobai” 202 dials the telephone number of the user “Xiaohei” 206, then the communication platform 208 directly sends the call request of the user “Xiaobai” 202 to the user “Xiaohei” 206 and establishes a call-type communication event between the two after the user “Xiaohei” 206 answers the telephone.

Alternatively, assuming that the user “Xiaobai” 202 sends an instant messaging message or an email to the user “Xiaohei” 206, then the communication platform 208 directly sends the instant messaging message or email to the user “Xiaohei” 206 and establishes an instant messaging-type or email-type communication event between the two after the user “Xiaohei” 206 views the instant messaging message or email.

2) In another case, as shown in FIG. 2B, assuming that the user “Xiaobai” 202 initiates a communication request for the user “Xiaohei” 206 to the communication platform 208, then the communication platform 208 establishes a communication connection with the user “Xiaobai” 202 and the user “Xiaohei” 206 respectively based on the communication request initiated by the user “Xiaobai” 202 and joins the two communication connections to implement a communication connection between the user “Xiaobai” 202 and the user “Xiaohei” 206, to establish a corresponding communication event 204.

For example, assume that the user “Xiaobai” 202 dials the telephone number of the user “Xiaohei” 206 (which may be implemented by using a call function provided by an EIM application such as “Ding Talk”). Then, the communication platform 208 will hang off the call, dial the user “Xiaobai” 202 on one hand, dial the user “Xiaohei” 206 on the other hand, and join the call to the user “Xiaobai” 202 with the call to the user “Xiaohei” 206, to establish a call-type communication event between the two users.

Certainly, there may be various types of communication event creating methods including the above cases (i.e., the call type, the instant messaging type, the email type, and the like) based on different processing logic of communication platforms. The present disclosure supports all corresponding communication events without imposing any limitation.

3. Determine Relationship Data

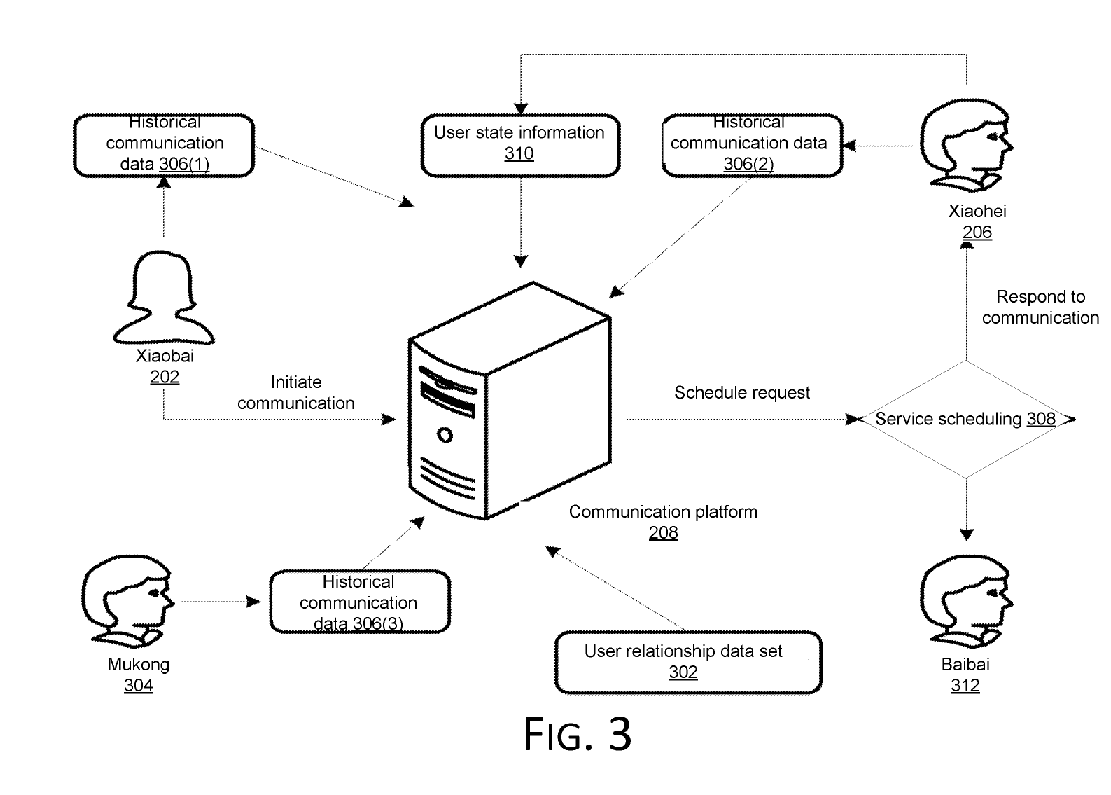

FIG. 3 is a schematic diagram of implementing a relationship prompt in a communication process according to an example embodiment of the present disclosure. As shown in FIG. 3, the communication platform 208 such as the Ding Talk unified communication platform processes a communication event between the user “Xiaobai” 202, the user “Xiaohei” 206, and the like. The Ding Talk unified communication platform may determine corresponding relationship data in various manners when detecting a communication event. The various manners of determining relationship data are described in detail below:

1) Based on a User Relationship Data Set

As an example embodiment, a user relationship data set 302 is pre-configured in the server, that is, user relationships between the user “Xiaobai” 202 and the user “Xiaohei” 206, between the user “Xiaobai” 202 and the user “Mukong” 304, and the like are pre-recorded. Therefore, the server may determine relationship data between the requester user and the responder user or an associated user according to the pre-configured user relationship data set.

As shown in FIG. 3, the server may install the communication platform 208 such as the Ding Talk unified communication platform in FIG. 3. When detecting a communication event in which the user “Xiaobai” 202 is the initiator user and the user “Xiaohei” 206 is the responder user, the communication platform 208 may determine relationship data between the user “Xiaobai” 202 and the user “Xiaohei” 206 by invoking the pre-configured user relationship data set 302.

Similarly, assume that the user “Mukong” 304 is an associated user of the user “Xiaohei” 206. Then, the communication platform 208 may further determine relationship data between the user “Xiaobai” 202 and the user “Mukong” 304 based on the user relationship data set 302 according to the association relationship between the user “Xiaohei” 206 and the user “Mukong” 304.

The user relationship data set 302 configured in the server may be pre-obtained by the server through data mining according to historical communication data between the requester user and the responder user or the associated user, such as historical communication data 306(1) from the user “Xiaobai” 202, historical communication data 306(2) from the user “Xiaohei” 206, and the historical communication data 306(3) from the user “Mukong” 304. For example, the historical communication data may include at least one of the following: an instant messaging message, a call record, a telephone message, an email, and the like. Thus, by acquiring and analyzing historical communication data corresponding to more users (e.g., all registered users), user relationship data that is more detailed and accurate may be obtained to form the user relationship data set maintained by the server.

Certainly, the server may also obtain the user relationship data set 202 in other manners which are not limited in the present disclosure. For example, the user relationship data set 302 may also be formed after data is entered completely by an administrator.

2) Based on real-time data analysis

As another example embodiment, the server does not need to maintain the user relationship data set 302 in advance and may determine the required relationship data in real time according to historical communication data between the requester user and the responder user or the associated user.

As shown in FIG. 3, when detecting a communication event in which the user “Xiaobai” 202 is the initiator user and the user “Xiaohei” 206 is the responder user, the communication platform 208 mines relationship data between the user “Xiaobai” 202 and the user “Xiaohei” 206 in real time by invoking historical communication data between the user “Xiaobai” 202 and the user “Xiaohei” 206.

Similarly, assume that the user “Mukong” 304 is an associated user of the user “Xiaohei” 206, the communication platform 208 may further mine relationship data between the user “Xiaobai” 202 and the user “Mukong” 304 in real time by invoking historical communication data between the user “Xiaobai” 202 and the user “Mukong” 304 according to the association relationship between the user “Xiaohei” 206 and the user “Mukong” 304.

For the source, type, and processing manner of the historical communication data, reference may be made to the process of forming the user relationship data set in “1) Based on a user relationship data set” above, which will not be repeated here.

4. Push Relationship Data

As shown in FIG. 3, when the user “Xiaobai” 202 initiates communication to the user “Xiaohei” 206, the communication platform 208 may push the relationship data between the user “Xiaobai” 202 and the user “Xiaohei” 206 to the user “Xiaohei” 206 serving as the responder user, such that the user “Xiaohei” 206 may infer a communication intent of the user “Xiaobai” 202 accordingly, thus helping improve the communication efficiency. Alternatively, when determining that the user “Xiaohei” 206 has an associated user “Mukong” 304, the communication platform 208 may push the relationship data between the user “Xiaobai” 202 and the user “Mukong” 304 to the user “Xiaohei” 206 serving as the responder user. Alternatively, the communication platform 208 may push both the relationship data between the user “Xiaobai” 202 and the user “Xiaohei” 206 and the relationship data between the user “Xiaobai” 202 and the user “Mukong” 304 to the user “Xiaohei” 206 serving as the responder user, such that the user “Xiaohei” 206 may infer a communication intent of the user “Xiaobai” 202 more comprehensively.

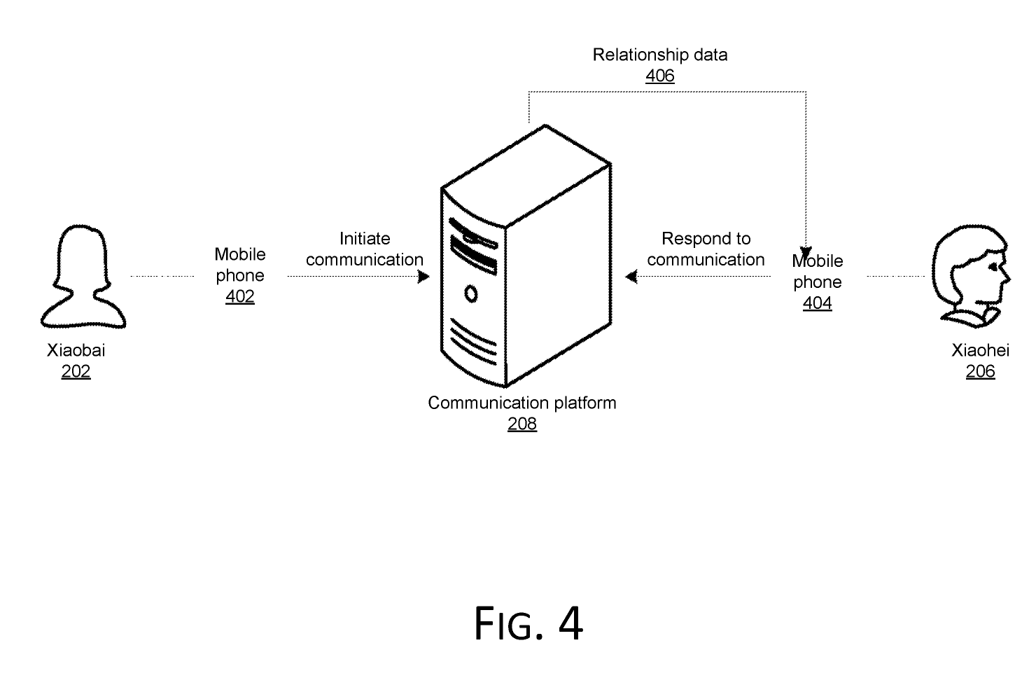

In an example embodiment, the associated device of the responder user is not only configured to display the relationship data, but also configured to respond to the communication event. As shown in FIG. 4, assume that the user “Xiaobai” 202 serving as the initiator user initiates communication by using a mobile phone 402, and the user “Xiaohei” 206 serving as the responder user responds to the communication by using a mobile phone 404. In this case, the mobile phone 404 may further be configured to display the relationship data 406 issued by the communication platform 208.

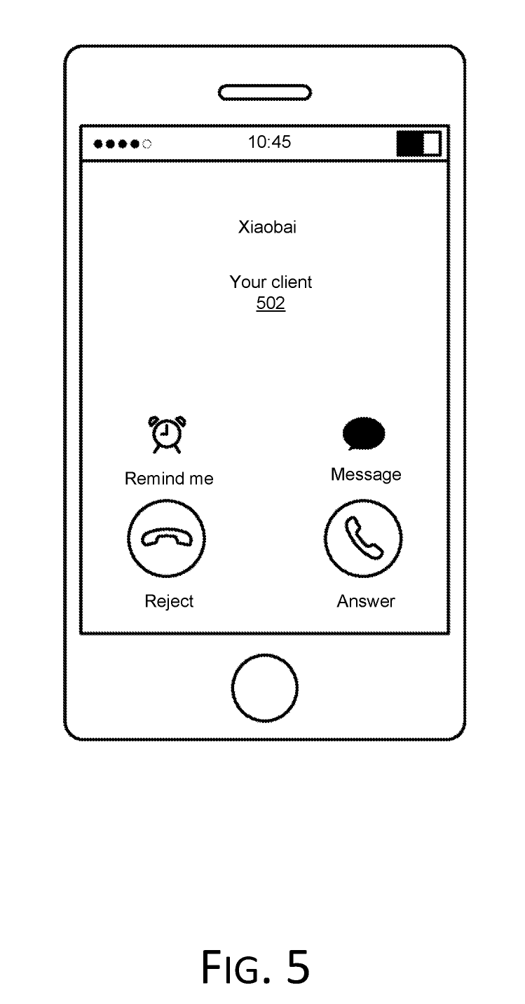

A “call”-type communication event is used as an example. As shown in FIG. 5, the relationship data between the user “Xiaobai” and the user “Xiaohei” may be displayed on the associated device of the user “Xiaohei”. For example, “Your Client” 502 shown in FIG. 5 indicates that the user “Xiaohei” and the user “Xiaobai” are in a “client” relationship.

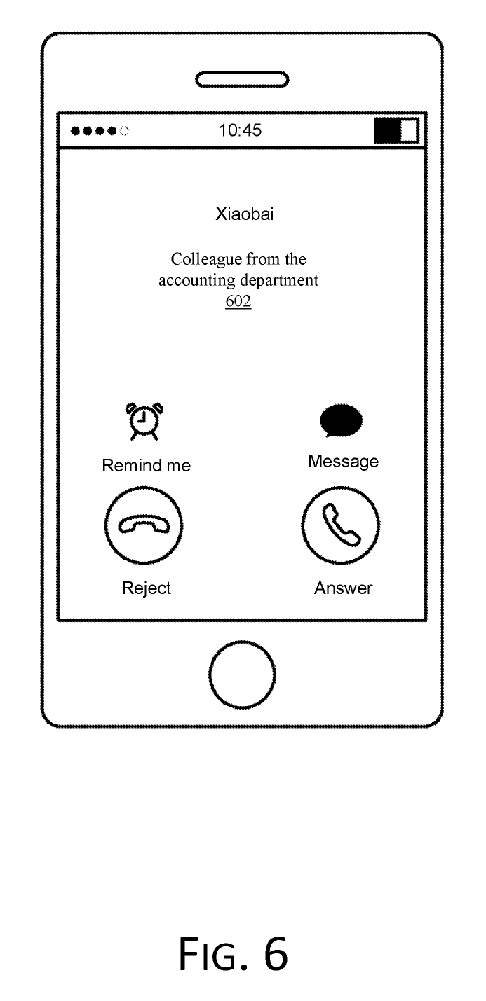

The “client” relationship corresponds to a “service” scenario. In this scenario, both parties of the relationship belong to different groups. For example, the user “Xiaohei” may be a service provider company serving as a Party B, and the user “Xiaobai” may be a service object company serving as a Party A. Certainly, the requester user and the responder user may belong to the same group. As shown in FIG. 6, when the user “Xiaobai” and the user “Xiaohei” belong to the same company and they are colleagues and the user “Xiaobai” belongs to the accounting department of the company, relationship data displayed may be “colleague from the accounting department” 602 as shown in FIG. 6. Correspondingly, for the users in the same group, the corresponding relationship data may be determined according to organizational structure information of the group. For example, when the foregoing manner based on the user relationship data set is adopted, the user relationship data set may include organizational structure information of the corresponding group to determine the relationship data.

It should be noted that:

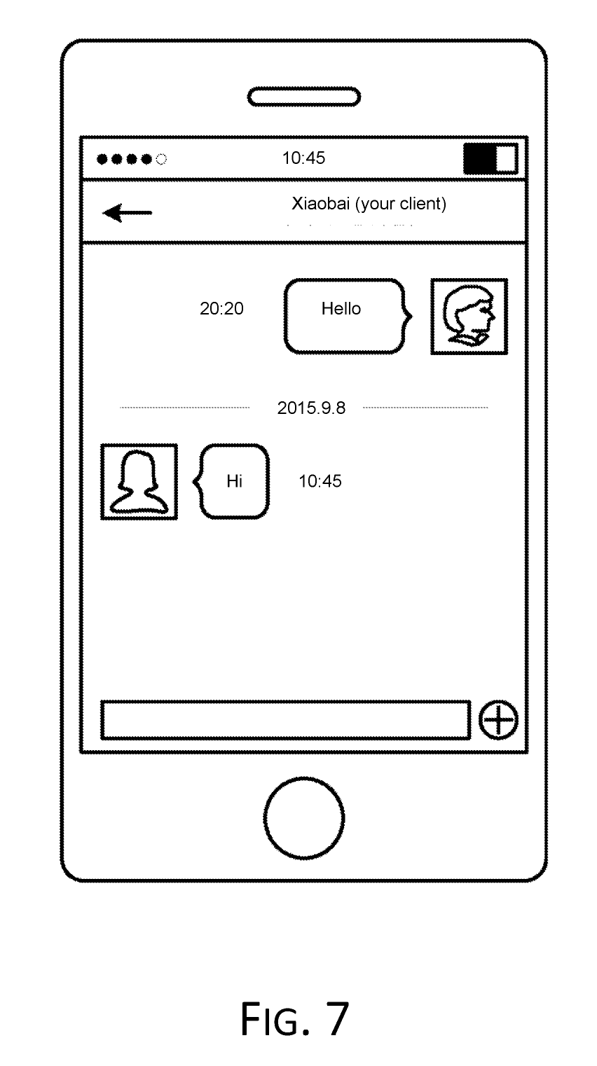

A. In addition to the “call”-type communication event, the technical solution of the present disclosure may further be applied to various types of communication events such as instant messaging, short message, and email. For example, FIG. 7 shows a communication interface in an instant messaging scenario. As shown in FIG. 7, assume that the user “Xiaobai” is the initiator user, and the user “Xiaohei” is the responder user, then FIG. 7 is a schematic diagram of an interface of an associated device of the user “Xiaohei”. Under the circumstance where the user “Xiaobai” only sends a greeting “Hi” to the user “Xiaohei”, after the relationship between the user “Xiaobai” and the user “Xiaohei” is indicated by “Your Client”, the user “Xiaohei” may predict a communication intent of the user “Xiaobai” without further description by the user “Xiaobai”, thus helping improve the efficiency of subsequent communication.

B. As described in the foregoing, the present disclosure may further obtain the relationship data between the initiator user and an associated user of the responder user and display the relationship data to the responder user. The server may recognize the associated user of the responder user in various manners, for example:

any user belonging to the same group as the responder user is determined as the associated user. For example, by using the “group” being an enterprise as an example, when the user “Mukong” and the user “Xiaohei” belong to the same enterprise, it may be determined that the user “Mukong” is the associated user of the user “Xiaohei”. Alternatively, when the user “Mukong” and the user “Xiaohei” belong to the same department (the department division is based on the enterprise organizational structure; or the department division is unrelated to the enterprise organizational structure) of the same enterprise, it may be determined that the user “Mukong” is the associated user of the user “Xiaohei”. It may be determined that the user “Mukong” is not an associated user when they belong to different departments.

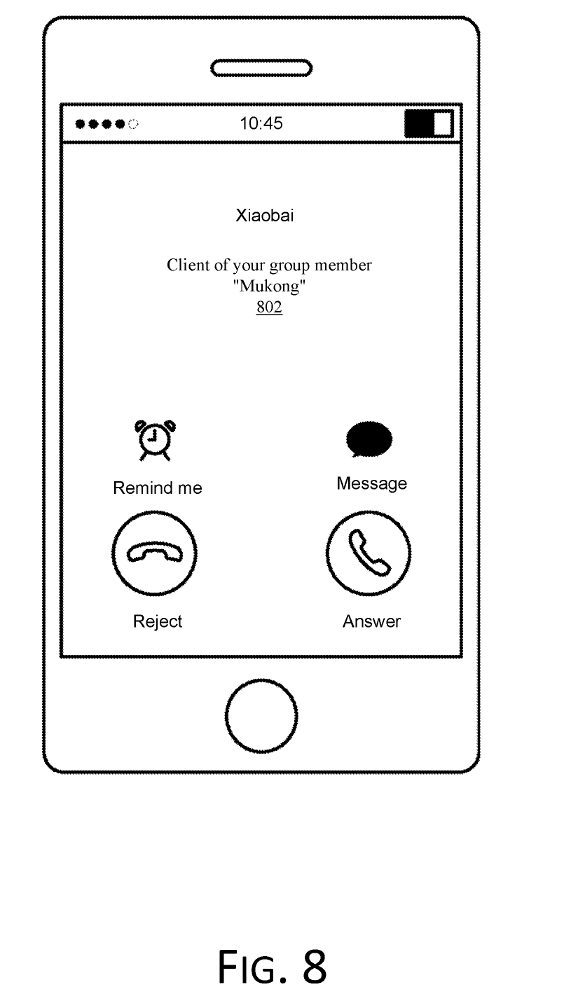

Further, comprehensive measurement may be conducted in combination with other factors. For example, when any user belongs to the same group as the responder user and there is an uncompleted task related to the requester user and the any user, the any user is determined as the associated user. By using the “group” being an enterprise as an example, when the user “Mukong” and the user “Xiaohei” belong to the same enterprise or belong to the same department of the same enterprise, if there is an uncompleted task between the user “Mukong” and the user “Xiaobai” serving as the initiator user, for example, the user “Mukong” and the user “Xiaobai” are cooperating for a certain project, the user “Mukong” may be used as the associated user of the user “Xiaohei” and presented as “Client of your group member ‘Mukong’” 802 as shown in FIG. 8. Therefore, the finally prompted relationship data is related to the project, and a more directive prompt operation may be formed for the user “Xiaohei”.

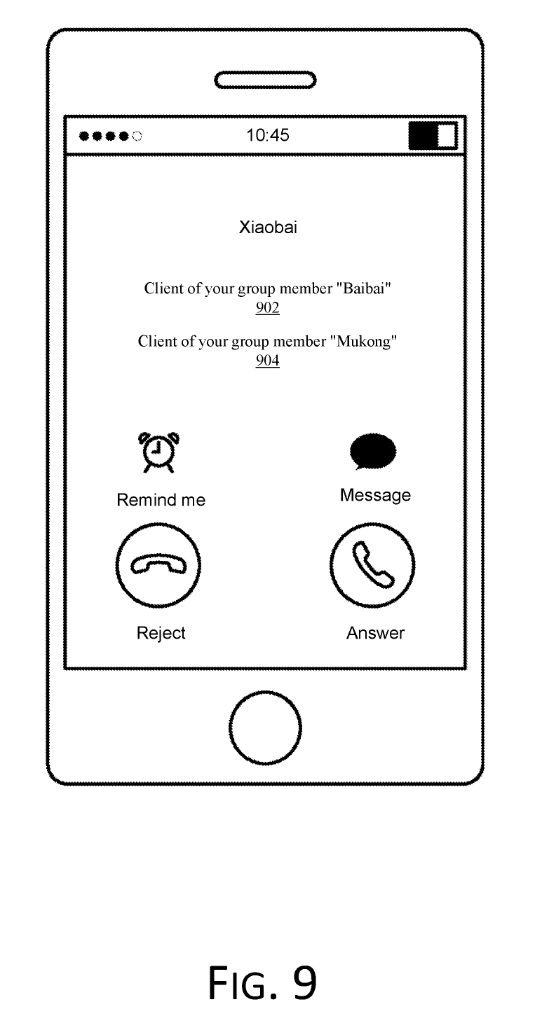

C. In the embodiment as shown in FIG. 5 to FIG. 8, the responder user may merely obtain one piece of relationship data. Alternatively, as shown in FIG. 9, the responder user may also obtain multiple pieces of relationship data, i.e., “Client of your group member ‘Baibai’” 902, “Client of your group member ‘Mukong’” 904, and the like.

When there are multiple pieces of relationship data, the multiple pieces of relationship data may be sorted and marked based on importance degrees, such that the multiple pieces of relationship data are arranged and displayed in a corresponding device according to importance degrees. As shown in FIG. 9, assume that an employee level of the user “Baibai” is higher than that of the user “Xiaohei”, and in this case, it may be considered that the importance degree of the relationship data corresponding to the user “Baibai” is higher than that of the relationship data corresponding to the user “Mukong”. Therefore, by sorting and marking the corresponding relationship data, “Client of your group member ‘Baibai’” 902 may be arranged above “Client of your group member ‘Mukong’” 904 on the associated device of the user “Xiaohei”.

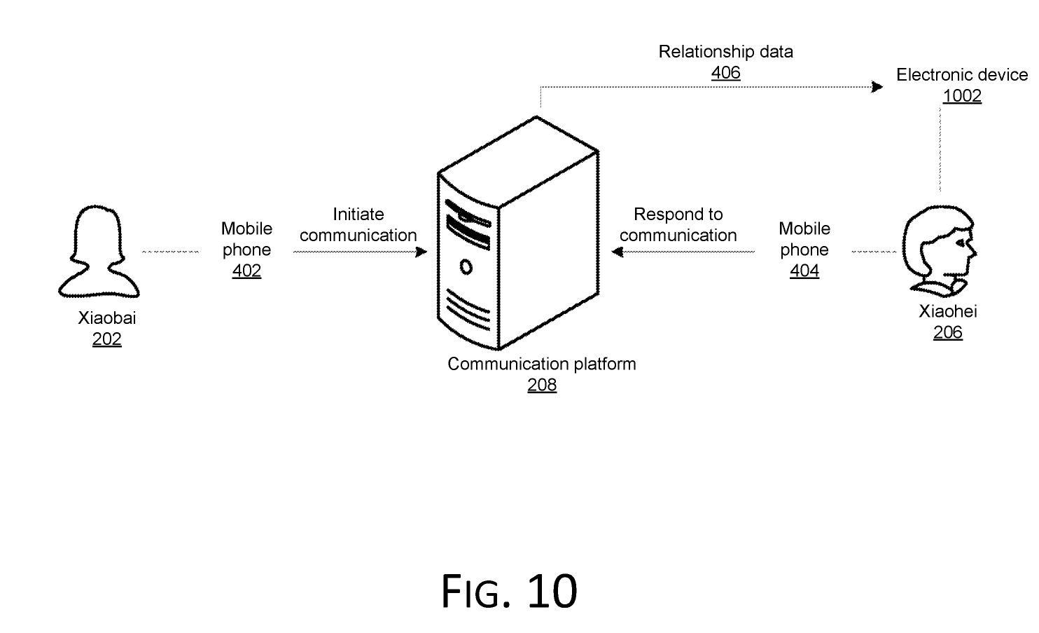

As another example embodiment, the responder user may respond to a communication event by using a preset device, and the preset device is different from the associated device of the responder user for displaying the relationship data. As shown in FIG. 10, as the initiator user, the user “Xiaobai” 202 uses the mobile phone 402 to initiate a communication event to the user “Xiaohei” 206. As the responder user, the user “Xiaohei” 206 uses a mobile phone 404 as a preset device to respond to the communication event of the user “Xiaobai” 202. Meanwhile, the user “Xiaohei” 202 uses an associated device different from the mobile phone 404 to prompt an uncompleted task, for example, the associated device may be an electronic device 1002 such as another mobile phone or a computer.

Interfaces of the associated devices when displaying the uncompleted task are similar to the terminal interfaces shown in FIG. 5 to FIG. 9. Details are not described here again.

5. Proxy User

In the above embodiment, the server may acquire state information of the responder user. When the state information indicates that the responder user cannot respond to the communication event, the server may search for a proxy user associated to the responder user, such that the responder user of the communication event is replaced with the proxy user, and the relationship data is pushed to the proxy user and displayed in an associated device of the proxy user.

Referring to the embodiment shown in FIG. 3, the communication platform 208 may use a “service scheduling” 306 function to schedule the communication event from the initiator user “Xiaobai” 202 and the corresponding relationship data to the user “Xiaohei” 206 when the user state information 310 of the user “Xiaohei” 206 indicates that the user “Xiaohei” 206 may respond to the communication event. When the user state information of the user 310 “Xiaohei” 206 indicates that the user “Xiaohei” 206 cannot respond to the communication event, the communication event from the initiator user “Xiaobai” 202 and the corresponding relationship data may be scheduled to a proxy user “Baibai” 312 of the user “Xiaohei” 206, to improve the communication efficiency.

6. Exceptional Case

In an example embodiment, the associated device of the responder user may store a local user relationship data set, and the local user relationship data set may further be synchronized to the server, to form server-side synchronous data corresponding to the local user relationship data set. Therefore, the server may acquire the server-side synchronous data of the local user relationship data set of the responder user, and when the server-side synchronous data includes pre-stored data matching the relationship data that needs to be pushed originally in the above embodiment, an operation of pushing the relationship data to the responder user may be canceled.

For example, the associated device of the responder user may be a mobile phone, and the local user relationship data set may be a local address book in the mobile phone. In this case, as the mobile phone of the responder user has stored the corresponding relationship data, that is, the mobile phone may display the relationship data by using the local address book, the relationship data does not need to be pushed and displayed repeatedly.

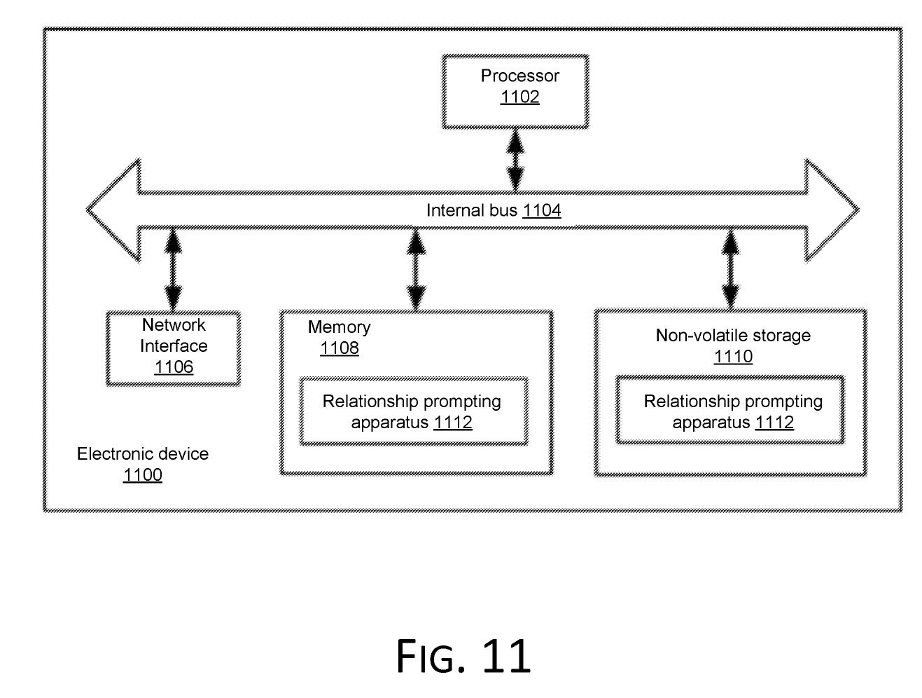

FIG. 11 is a schematic structural diagram of an electronic device according to an example embodiment of the present disclosure. Referring to FIG. 11, on the hardware level, the electronic device 1100 includes a processor 1102, an internal bus 1104, a network interface 1106, a memory 1108, and a non-volatile storage 1110, and certainly, may further include hardware required by other services. The processor 1102 reads a corresponding computer program from the non-volatile storage 1110 to the memory 1108 and runs the computer program, thereby forming a relationship prompting apparatus 1112 in a communication process on the logic level. Certainly, in addition to the software implementation, the present disclosure does not exclude other implementations, such as logic devices or a combination of software and hardware. In other words, entities executing the following processing process are not limited to various logic units, and may also be hardware or logic devices. Both the memory 1108 and the non-volatile storage 1110 are examples of computer readable medium.

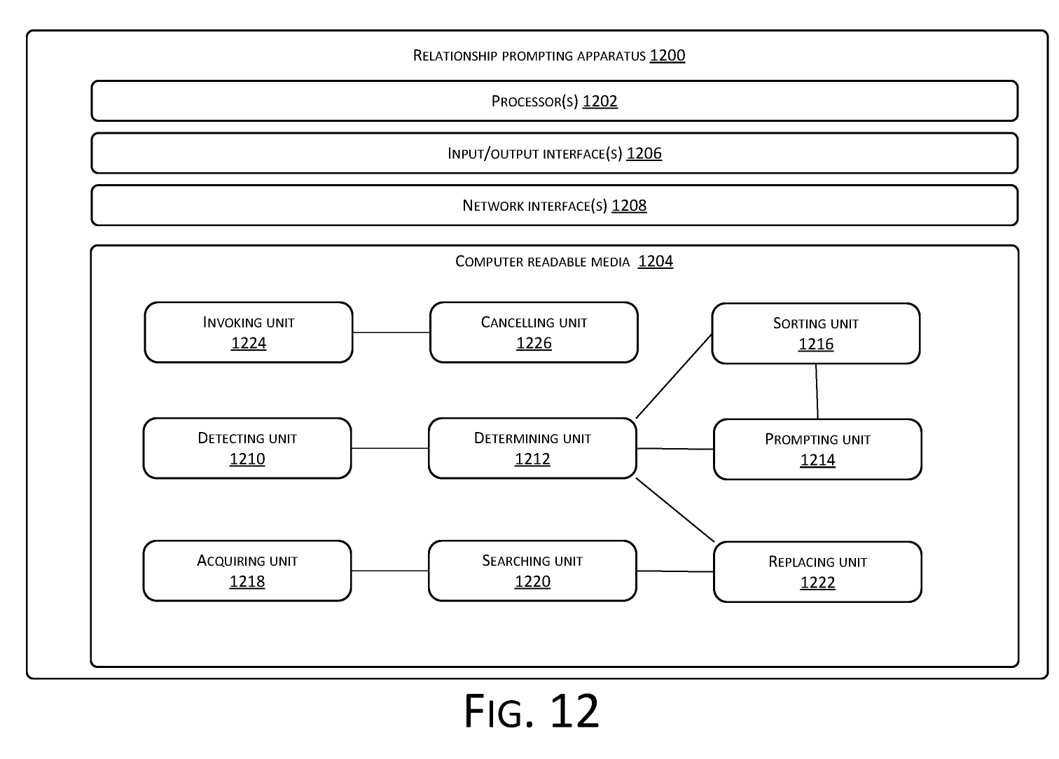

Referring to FIG. 12, in a software implementation, the relationship prompting apparatus 1200 includes one or more processor(s) 1202 or data processing unit(s) and computer readable media 1204. The relationship prompting apparatus 1200 may further include one or more input/output interface(s) 1206 and one or more network interface(s) 1208.

The computer readable media 1204 may store therein a plurality of modules or units including: a detecting unit 1210, a determining unit 1212, and a prompting unit 1214, wherein

the detecting unit 1210 is configured to detect a communication event;

the determining unit 1212 is configured to determine relationship data between a requester user and a responder user or an associated user corresponding to the responder user of the communication event; and

the prompting unit 1214 is configured to push the relationship data to the responder user such that the relationship data is displayed in an associated device of the responder user.

Optionally, any user belonging to the same group as the responder user is determined as the associated user.

Optionally, the any user is determined as belonging to the same group as the responder user when the any user and the responder user belong to the same enterprise or belong to the same department of the same enterprise.

Optionally, any user is determined as the associated user when the any user and the responder user belong to the same group and there is an uncompleted task related to the requester user and the any user.

Optionally, the determining unit 1212 is specifically configured to:

determine the relationship data between the requester user and the responder user or the associated user according to a pre-configured user relationship data set.

Optionally, when the requester user and the responder user belong to the same group, the user relationship data set includes: organizational structure information of the group.

Optionally, the determining unit 1212 is specifically configured to:

determine the relationship data according to historical communication data between the requester user and the responder user or the associated user.

Optionally, the computer readable media 1204 may further store therein a sorting unit 1216 configured to: when there are multiple pieces of relationship data, sort and mark the multiple pieces of relationship data according to importance degrees, such that the multiple pieces of relationship data are arranged and displayed in a corresponding device according to importance degrees.

Optionally, the associated device of the responder user is further configured to respond to the communication event; or

the responder user responds to the communication event by using a preset device different from the associated device of the responder user.

Optionally, the communication event is a call event initiated to the responder user by the requester user using an instant messaging application.

Optionally, the communication event is an instant messaging event initiated to the responder user by the requester user using an instant messaging application.

Optionally, the instant messaging application is an enterprise instant messaging application.

Optionally, the computer readable media 1204 may further store therein:

an acquiring unit 1218 configured to acquire state information of the responder user;

a searching unit 1220 configured to search for a proxy user associated with the responder user when the state information indicates that the responder user is unable to respond to the communication event; and

a replacing unit 1222 configured to replace the responder user of the communication event with the proxy user and push the relationship data to the proxy user such that the relationship data is displayed in an associated device of the proxy user.

Optionally, the computer readable media 1204 may further store therein:

an invoking unit 1224 configured to invoke server-side synchronous data of a local user relationship data set of the responder user; and

a canceling unit 1226 configured to cancel the operation of pushing the relationship data to the responder user when the server-side synchronous data includes pre-stored data matching the relationship data.

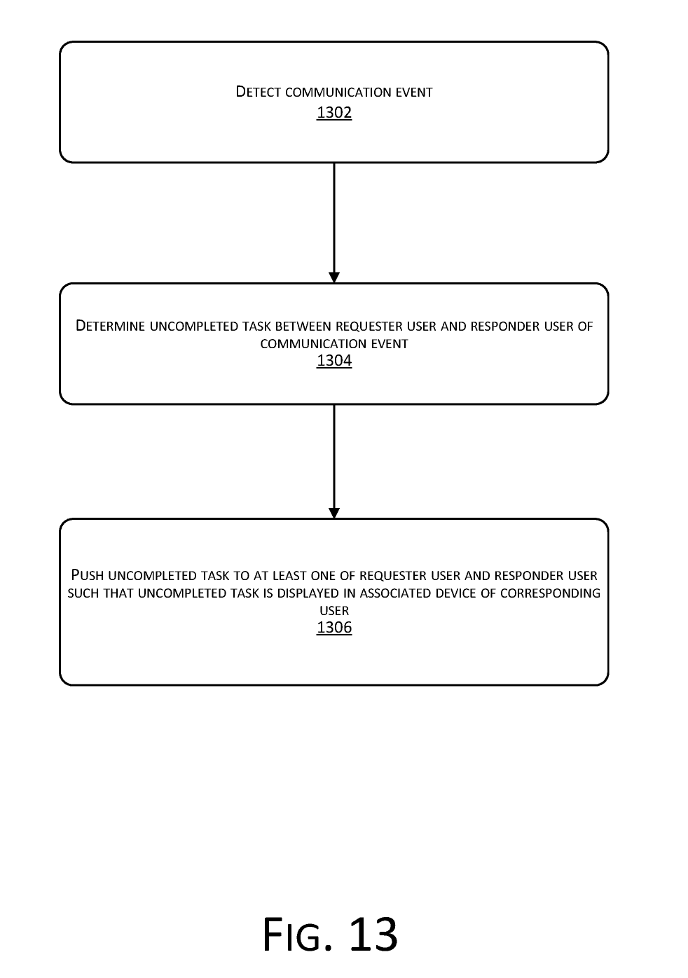

FIG. 13 is a flowchart of a task prompting method in a communication process according to an example embodiment of the present disclosure. As shown in FIG. 13, the method is applied to a server, and may include the following steps:

Step 1302: A communication event is detected.

In this embodiment, the server bears a communication platform. The user may initiate a communication event to another user through the communication platform, and the communication platform may detect existing communication events accordingly.

In this embodiment, the communication event may be a real-time communication event, such as a call event, or an instant messaging event. Certainly, the communication event may also be a non-real-time communication event. For example, after the requester user sets communication content and a communication time, the communication platform establishes a communication event at the set communication time, and transmits the set communication content to the responder user.

For a non-real-time communication event, using a “DING message” function provided by the enterprise instant messaging application “Ding Talk” as an example: the requester user may use a sent instant messaging message or any message separately set by the user as the communication content of the “DING message”, and set any time point as the communication time of the “DING message”. Then, a server corresponding to “Ding Talk” may initiate a “DING message” to the responder user, which specifically includes: converting the set communication content into audio, initiating a telephone call to the responder user, and playing the audio to the responder user after the responder user answers the call, thus completing the non-real-time communication event.

Step 1304: An uncompleted task related to a requester user and a responder user of the communication event is determined.

In this embodiment, a user initiating the communication is the requester user, and a user responding to the communication is the responder user. For example, when user A dials a telephone number of user B, the user A is considered as a requester user and the user B is considered as a responder user.

In this embodiment, the uncompleted task may be any uncompleted event related to the requester user and the responder user, for example, any event such as an appointment (e.g., go shopping) between the requester user and the responder user, and a piece of work content (e.g., the requester user entrusts the responder user to conduct software testing in advance).

Step 1306: The uncompleted task is pushed to at least one of the requester user and the responder user to be displayed in an associated device of the corresponding user.

As may be seen from the foregoing technical solution, during processing of the communication event in the present disclosure, the uncompleted task related to the requester user and the responder user is determined, such that when the uncompleted task is pushed to and displayed in the associated device of the requester user, the requester user may view and know all uncompleted tasks at any time, avoiding repeated communication due to forgetting. Meanwhile, when the uncompleted task is pushed to and displayed in the associated device of the responder user, the responder user may know the communication intent of the requester user in time and get prepared accordingly; the requester user does not need to describe and explain the uncompleted task, thus shortening the communication time and improving the communication efficiency.

1. Reference may be made to the description above for the client terminal application and the communication platform, which will not be repeated here.

2. Reference may be made to the descriptions of FIG. 2A and FIG. 2B for creation of the communication event, which will not be repeated here.

3. Task prompting in a communication process

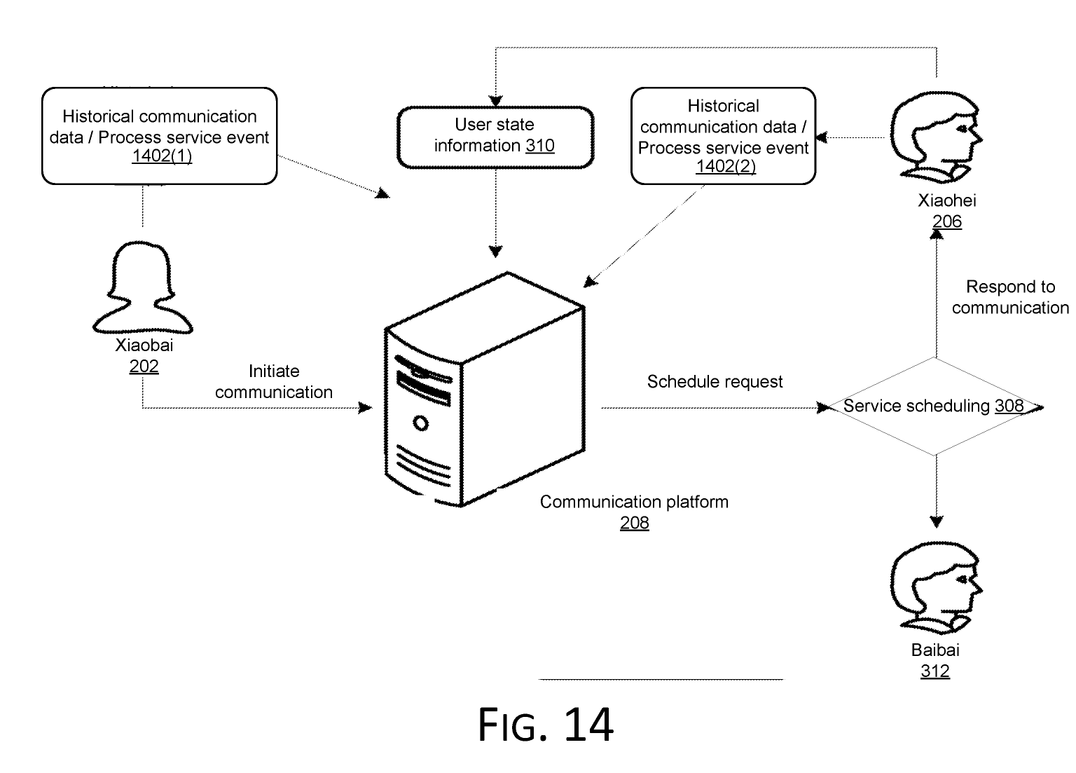

FIG. 14 is a schematic diagram of implementing a task prompt in a communication process according to an example embodiment of the present disclosure. In addition to the historical communication data in FIG. 3, the communication platform 208 consider both the historical communication data and the process service event such as the historical communication data and process service event 1402(1) from the user “Xiaobai” 202 and historical communication data and the process service event 1402(2) from the user “Xiaohei” 206 when finding the relationship between users.

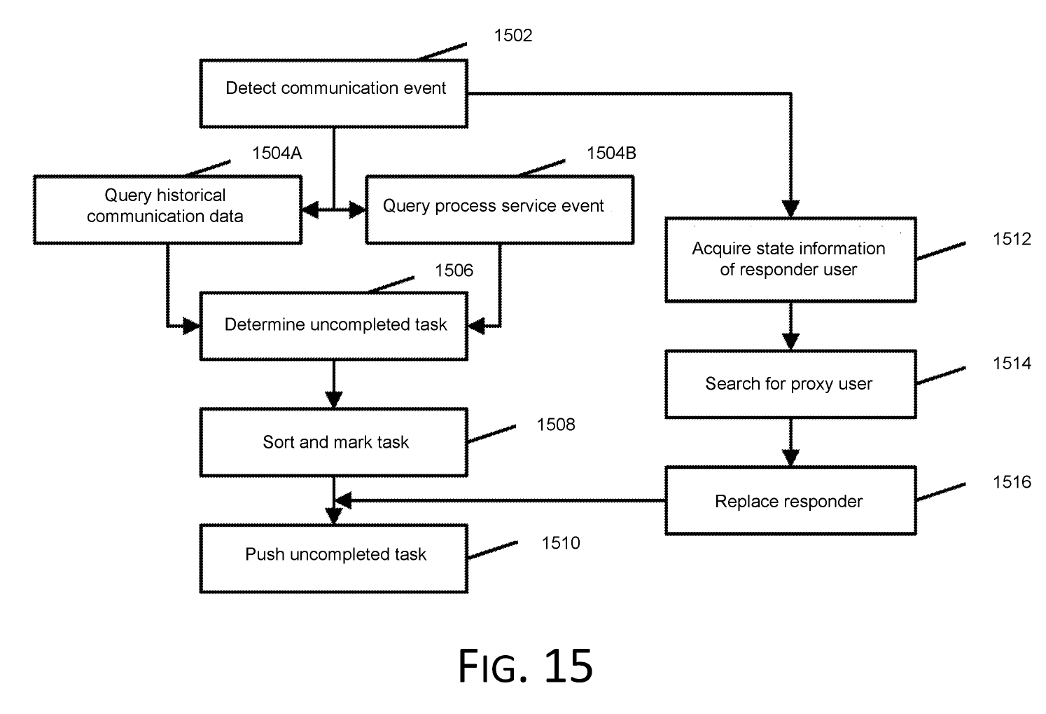

FIG. 15 is a flowchart of a task prompting method in another communication process according to an example embodiment of the present disclosure. As shown in FIG. 15, the process of implementing a task prompt in a communication process may include the following steps:

Step 1502: A communication event is detected.

In this embodiment, the task prompting method shown in FIG. 15 is applied to a server, and the server has a communication platform as shown in FIG. 14, such as the Ding Talk unified communication platform, which processes a communication event between users such as the user “Xiaobai” and the user “Xiaohei”.

Step 1504A: Historical communication data is queried, the historical communication data being related to an initiator user and a responder user.

Step 1504B: A process service event is queried, the process service event being related to the initiator user and the responder user.

Step 1506: An uncompleted task is determined.

In the technical solution of the present disclosure, based on the detected communication event, a corresponding uncompleted task may be determined in various manners, e.g., the two manners shown in step 1504A and step 1504B. The two manners shown in step 1504A and step 1504B are illustrated with examples respectively.

Manner 1: Based on Historical Communication Data

As an example embodiment, an uncompleted task may be determined according to historical communication data between the requester user and the responder user.

The historical communication data may include historical data of any communication type. For example, the communication type may include: instant messaging, call, email, and the like; and the corresponding historical communication data includes at least one of the following: an instant messaging message, a call records, a telephone message, and an email. Correspondingly, for different types of historical communication data, corresponding uncompleted tasks may be determined in the following manners respectively:

1) Instant Messaging Message

When the historical communication data is an instant messaging message, the uncompleted task may be an instant messaging query request that is initiated by the requester user to the responder user and has not been answered yet.

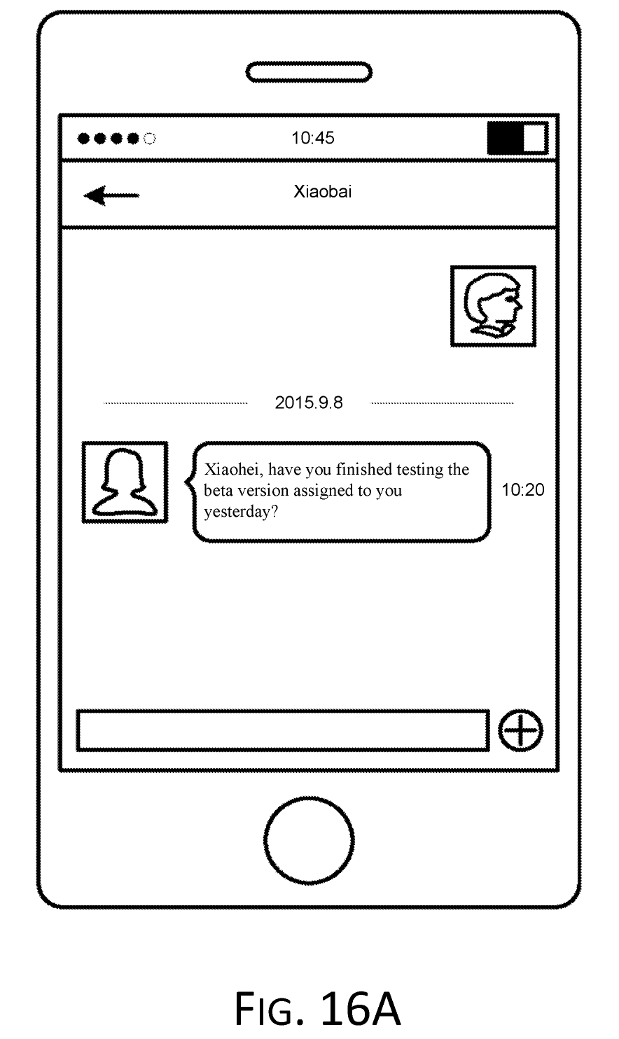

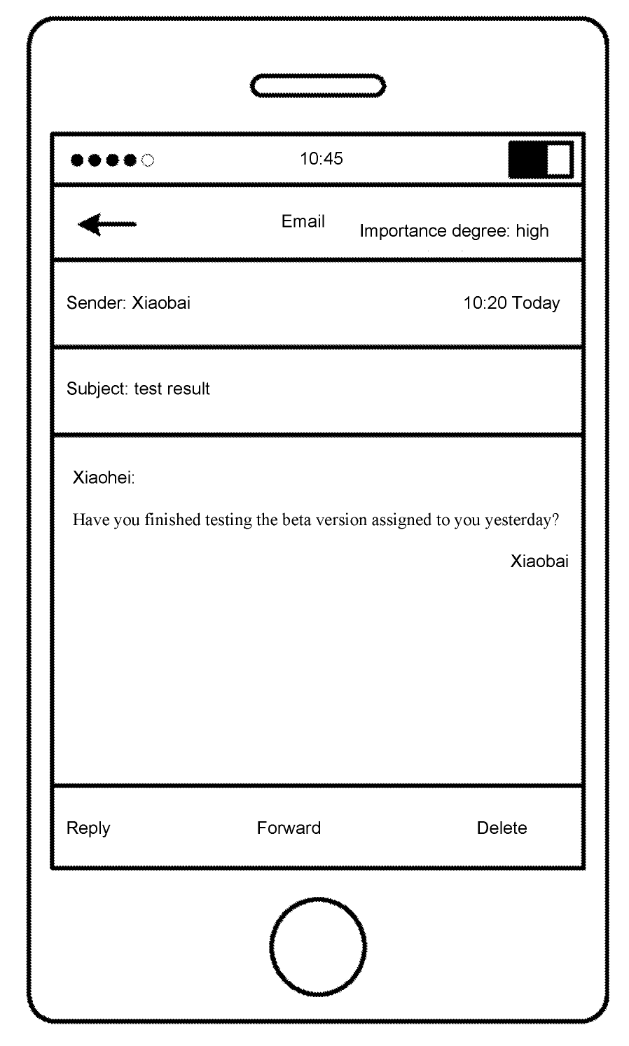

As shown in FIG. 16A, assume that the user “Xiaobai” sends an instant messaging message to the user “Xiaohei” at 10:20, and content of the message is “Xiaohei, have you finished testing the beta version assigned to yesterday?” When the user “Xiaobai” initiates a communication event to the user “Xiaohei” at 10:45, the instant messaging message is still not replied, that is, the instant messaging query request initiated by the user “Xiaobai” to the user “Xiaohei” is not answered. In this case, the instant messaging query request is used as the uncompleted task between the user “Xiaobai” and the user “Xiaohei”.

Whether there is an unanswered instant messaging query request may be determined according to the quantity (historical total quantity or quantity in a certain period of time) of received and transmitted instant messaging messages. For example, in FIG. 16A, the quantity of messages sent by the user “Xiaobai” is 1, and the quantity of messages sent by the user “Xiaohei” is 0; therefore, it is determined that there is an unanswered instant messaging query request.

Alternatively, the content of the instant messaging message may further be analyzed to improve the correctness of judgment. For example, when the content of the instant messaging message sent by the user “Xiaobai” is “hi”, it is actually a greeting and should not be considered as a “task”. When the content of the instant messaging message sent by the user “Xiaobai” is that “Xiaohei, have you finished testing the beta version assigned to yesterday?”, it may be determined according to query word or punctuation such as “have you”, “?”, and even a semantic analysis that the content is for the purpose of “query”. Therefore, the techniques of the present disclosure determine that there is an unanswered instant messaging query request.

2) Email

When the historical communication data is an email, the uncompleted task includes at least one of the following: email content having a preset importance degree and related to the requester user and the responder user, and an item that is discussed by the requester user and the responder user via an email and has not been completed yet.

A. Importance degree. Each email has a corresponding importance degree, which may be set by the user as required. As shown in FIG. 16B, the importance degree of the email is set to “high” by the user “Xiaohei”; hence, without analyzing the content and other aspects of the email, the techniques of the present disclosure may consider that the user “Xiaobai” is likely to discuss items related to the email with the user “Xiaohei”. Therefore, the email is used as the uncompleted task.

B. Email communication item. As shown in FIG. 16B, the techniques of the present disclosure may determine that there is an uncompleted item between the user “Xiaobai” and the user “Xiaohei” by extracting the email content “Xiaohei, have you finished testing the beta version assigned to yesterday?” and by using a processing process similar to that of the “instant messaging message”, i.e., when the quantities of emails of the two parties are inconsistent or it is determined that the email is not answered according to the email content. The uncompleted item may be used as the uncompleted task between the two users.

3) Call Record or Telephone Message

When the historical communication data is a call record, the uncompleted task is a missed call record that is initiated by the requester user to the responder user and has not been processed yet. Alternatively, when the historical communication data is a telephone message, the uncompleted task is telephone message content that is initiated by the requester user to the responder user and has not been processed yet.

The historical communication data in the above two forms is similar. In both forms, the historical communication data is initiated by the user “Xiaobai” to the user “Xiaohei” and has not been processed by the user “Xiaohei”. Moreover, the historical communication data may be used as the corresponding uncompleted task as long as it is ensured that the data is related to the user “Xiaobai” and the user “Xiaohei”, without the need to consider specific data content analysis and the like.

The user “Xiaohei” may process the missed call record by calling the user “Xiaobai” back. Therefore, if the user “Xiaohei” has not called the user “Xiaobai” back, it is considered that the missed call record has not been processed. The user “Xiaohei” may process the telephone message by listening to specific content of the telephone message. Therefore, if the user “Xiaohei” has not listened to the telephone message, it is considered that the telephone message has not been processed.

Manner 2: Based on a Process Service Event

As another example embodiment, a process service event related to the requester user and the responder user may be acquired, and an uncompleted process service event is used as the uncompleted task.

In this embodiment, the process service event is actually a process-type service event involving both the requester user and the responder user. For example, in an application scenario of “enterprise management”, the process service event may include one of the following: an examination and approval service event, a collaboration service event, and an attendance management event. Certainly, the technical solution of the present disclosure may also be applied to other scenarios, and the process service event will vary correspondingly, which is not limited in the present disclosure. For example, in an application scenario of “social”, the process service event may include: party invitation, group membership application, and the like.

The “examination and approval service event” is used as an example. Assume that the user “Xiaobai” initiates a vacation examination and approval event to the user “Xiaohei” in advance. If the examination and approval event has not been processed when the user “Xiaobai” initiates a communication event to the user “Xiaohei”, that is, the user “Xiaohei” has not fed back an examination and approval result to the user “Xiaobai”, the user “Xiaobai” probably wants to know or urge the processing of the examination and approval event. Therefore, the vacation examination and approval event may be used as the uncompleted task.

The “collaboration service event” is used as an example. Assume that the user “Xiaobai” is a developer, the user “Xiaohei” is a tester, and they have a collaboration relationship in work. Then, it is considered that there is a corresponding collaboration service event as long as the collaboration relationship is not canceled. Therefore, the user “Xiaobai” will probably discuss the collaboration content with the user “Xiaohei” when initiating a communication event to the user “Xiaohei”. Thus, the collaboration service event may be used as the uncompleted task.

The “attendance management event” is used as an example. Assume that the user “Xiaobai” is a department manager, and the user “Xiaohei” is a department member. If the user “Xiaohei” has not clocked in, the user “Xiaobai” is likely to ask a question about the attendance when initiating a communication event to the user “Xiaohei”. Thus, the attendance management event may be used as the uncompleted task.

Step 1508: Tasks are sorted and marked.

In this embodiment, when there are multiple uncompleted tasks, the multiple uncompleted tasks may be sorted and marked according to importance degrees. As such, when pushed to the associated device of the requester user or the responder user, the multiple uncompleted tasks are arranged and displayed in the associated device according to importance degrees, so that the corresponding user may view the uncompleted tasks conveniently.

Step 1510: The uncompleted task is pushed.

In this embodiment, the Ding Talk unified communication platform may push the uncompleted task to at least one of the requester user and the responder user such that the uncompleted task is displayed in an associated device of the corresponding user. For example, when the initiator user is the user “Xiaobai” and the responder user is the user “Xiaohei”, the Ding Talk unified communication platform may send the uncompleted task to the user “Xiaobai”, such that the uncompleted task displayed in the associated device of the user “Xiaobai” may remind the user “Xiaobai”, avoiding omission when there are too many uncompleted tasks or during chatting. Alternatively, the Ding Talk unified communication platform may also send the uncompleted task to the user “Xiaohei”. Thus, the user “Xiaohei” may understand the communication intent of the user “Xiaobai” without a prompt from the user “Xiaobai”, thus shortening the communication duration and improving the communication efficiency. Certainly, the Ding Talk unified communication platform may also push the uncompleted task to the user “Xiaobai” and the user “Xiaohei” at the same time.

As an example embodiment, the associated devices of the requester user and the responder user may also be configured to process the communication event and prompt the uncompleted task simultaneously.

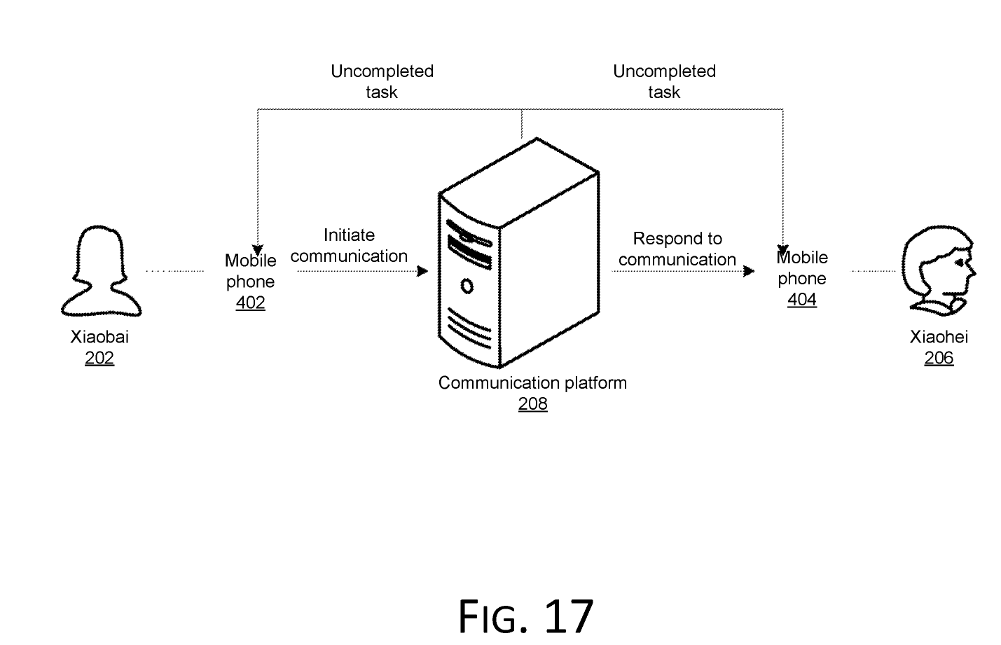

As shown in FIG. 17, as the initiator user, the user “Xiaobai” 202 only uses a mobile phone 402 as an associated device. The mobile phone 402 is not only configured to receive and display an uncompleted task, but also configured to initiate a communication event to the user “Xiaohei” 206.

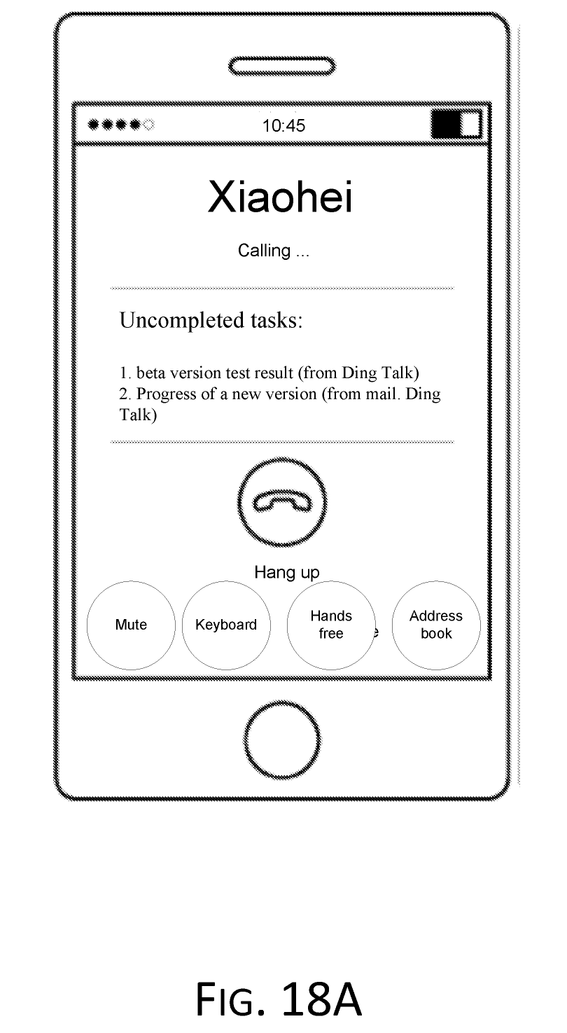

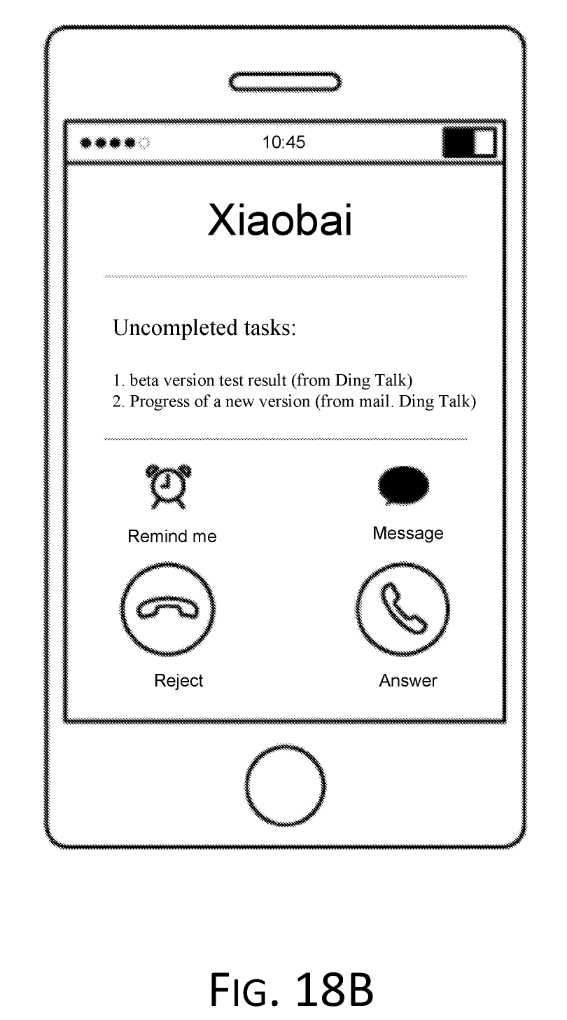

By using a “call”-type communication event as an example, FIG. 18A shows an interface of the mobile phone 402 during a call (FIG. 18A is an interface before the call is put through, wherein an interface after the call is put through is similar may also display an uncompleted task), in which uncompleted tasks related to the user “Xiaobai” and the user “Xiaohei” are shown, including “1. beta version test result” and “2. Progress of a new version”. Certainly, the quantity of uncompleted tasks may be one or more, which is not limited in the present disclosure. The two uncompleted tasks shown in FIG. 18A may be arranged in a random order or may be arranged according to importance degrees based on sorting and marking by the Ding Talk unified communication platform.

Further, as shown in FIG. 18A, a corresponding source of each uncompleted task may be further labeled. For example, “1. beta version test result” is obtained from an instant messaging message in an instant messaging application “Ding Talk”, and therefore, is marked as “from Ding Talk”. Similarly, assume that “2. Progress of a new version” is obtained from “mail. Ding Talk”; therefore, it is marked as “from mail. Ding Talk”.

Similarly, as the responder user, the user “Xiaohei” only uses a mobile phone 404 as an associated device. The mobile phone 404 is not only configured to receive and display an uncompleted task, but also configured to respond to the communication event from the user “Xiaobai”. Then, corresponding to FIG. 18A, FIG. 18B shows an interface of the mobile phone 404 during a call (FIG. 18B is an interface before the call is put through, wherein an interface after the call is put through is similar and may also display an uncompleted task), in which uncompleted tasks related to the user “Xiaobai” and the user “Xiaohei” are shown, including “1. beta version test result” and “2. Progress of a new version”, identical to the uncompleted tasks shown in FIG. 18A. Likewise, the two uncompleted tasks as shown in FIG. 18B may also be arranged in a random order or arranged according to importance degrees based on sorting and marking by the Ding Talk unified communication platform. Moreover, in FIG. 18B, a source of each uncompleted task may also be marked. Details are not described here again.

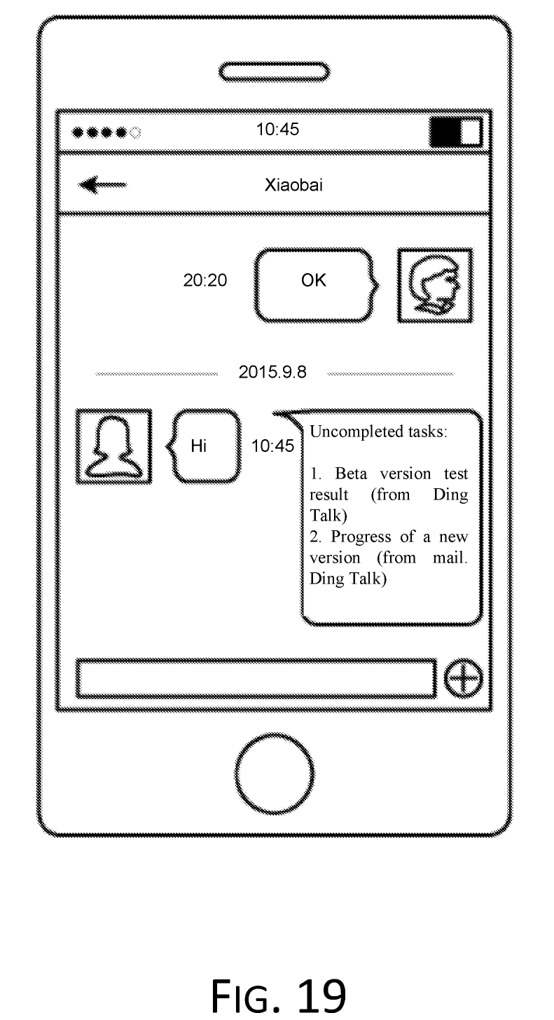

Moreover, as described above, there may be various types of communication events in the present disclosure, and further description is made below by using an “instant messaging”-type communication event as an example. As shown in FIG. 19, assume that the user “Xiaobai” is the initiator user, and the user “Xiaohei” is the responder user. FIG. 19 is a schematic diagram of an interface of an associated device of the user “Xiaohei”. When the user “Xiaobai” merely sends a greeting “Hi” to the user “Xiaohei”, the server may predict a communication intent of the user “Xiaobai” with further description by the user “Xiaobai”, and a corresponding uncompleted task is prompted in the instant messaging interface of the associated device of the user “Xiaohei”, so that the user “Xiaohei” may view the uncompleted task conveniently, thus improving the efficiency of subsequent communication.

As another example embodiment, the associated devices of the requester user and the responder user may be merely configured to prompt the uncompleted task respectively, and the communication event is processed by using other devices. For example, the requester user initiates the communication event by using a first device different from the associated device of the requester user. The responder user responds to the communication event by using a second device different from the associated device of the responder user.

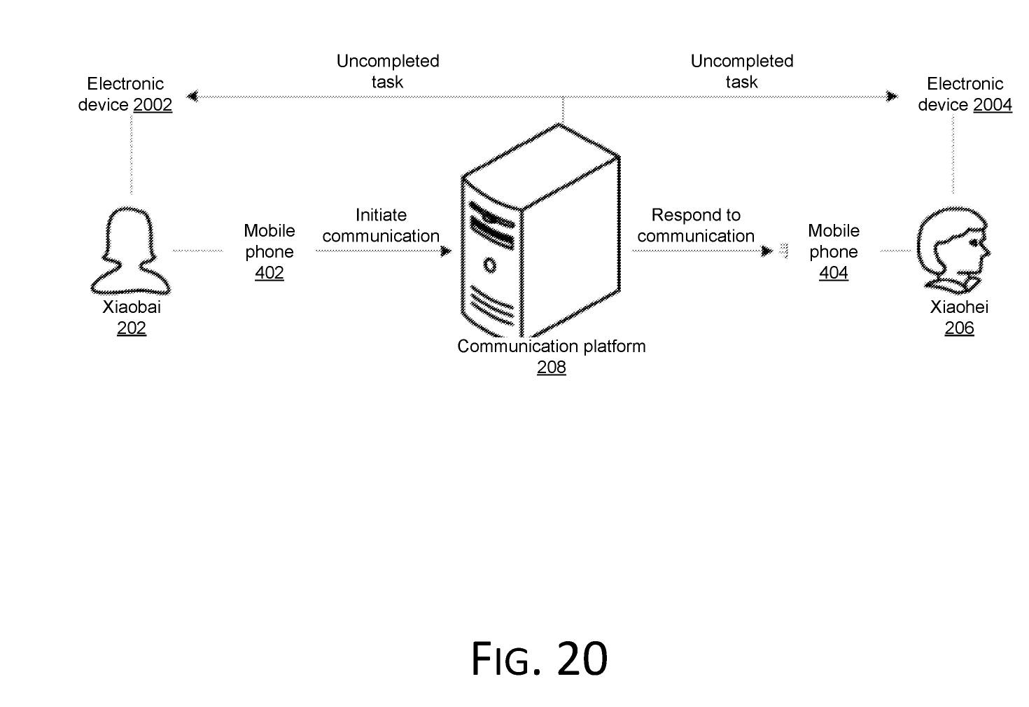

As shown in FIG. 20, as the initiator user, the user “Xiaobai” 202 uses the mobile phone 402 as the first device to initiate a communication event to the user “Xiaohei” 206. As the responder user, the user “Xiaohei” 206 uses a mobile phone 404 as the second device to respond to the communication event of the user “Xiaobai” 202. Meanwhile, the user “Xiaobai” 202 uses an associated device different from the mobile phone 402 to prompt the uncompleted task. For example, the associated device may be an electronic device 2002 such as another mobile phone 3 or a computer 1. The user “Xiaohei” 206 uses an associated device different from the mobile phone 404 to prompt the uncompleted task, for example, the associated device may be an electronic device 2004 such as another mobile phone 4 or a computer 2.

By using the “call”-type communication event as an example, interfaces of the associated devices when displaying the uncompleted task are similar to the terminal interfaces shown in FIG. 18A to FIG. 18B. Details are not described here again.

Moreover, in the embodiment shown in FIG. 15, except for the common communication between the requester user and the responder user, it may be inconvenient for the responder user to perform effective response or communication with respect to the communication event established by the initiator user. This problem may be solved through the following steps 1512 to 1516.

Step 1512: State information of the responder user is acquired.

In this embodiment, steps 1512 to 1516 are only required to be performed after the step 1502 and before step 1510, and do not have necessary sequential order or dependency with other steps.

In this embodiment, in an application scenario of “enterprise management”, state information of an enterprise employee as the responder user may be recorded in a “state management sub-system” in an enterprise management system or in another similar sub-system. Therefore, the Ding Talk unified communication platform may acquire the state information of the responder user by accessing the enterprise management system or the corresponding sub-system.

In this embodiment, the Ding Talk unified communication platform may also acquire event states such as attendance and vacation of the responder user, or acquire real-time geographic position information of the responder user, thus speculating the state information of the responder user.

Step 1514: A proxy user is searched for.

In this embodiment, a proxy user associated with the responder user is searched for when the state information indicates that the responder user is unable to process the uncompleted task. The prediction result is related to the communication intent of the initiator user and the uncompleted task. Therefore, when the responder user is unable to process the uncompleted task, a proxy user that may process the uncompleted task should respond to the communication event, to help improve the communication efficiency.

Step 1516: The responder is replaced.

In this embodiment, the responder user of the communication event is replaced with the proxy user, and the uncompleted task is pushed to the proxy user to be displayed in an associated device of the proxy user.

As may be seen with reference to FIG. 14, the Ding Talk unified communication platform may use a “service scheduling” function to schedule the communication event from the initiator user “Xiaobai” and the corresponding uncompleted task to the user “Xiaohei” when the state information of the user “Xiaohei” indicates that the user “Xiaohei” may process the uncompleted task. When the state information of the user “Xiaohei” indicates that the user “Xiaohei” cannot process the uncompleted task, the communication event from the initiator user “Xiaobai” and the corresponding uncompleted task may be scheduled to a proxy user “Baibai” of the user “Xiaohei”, to improve the communication efficiency.

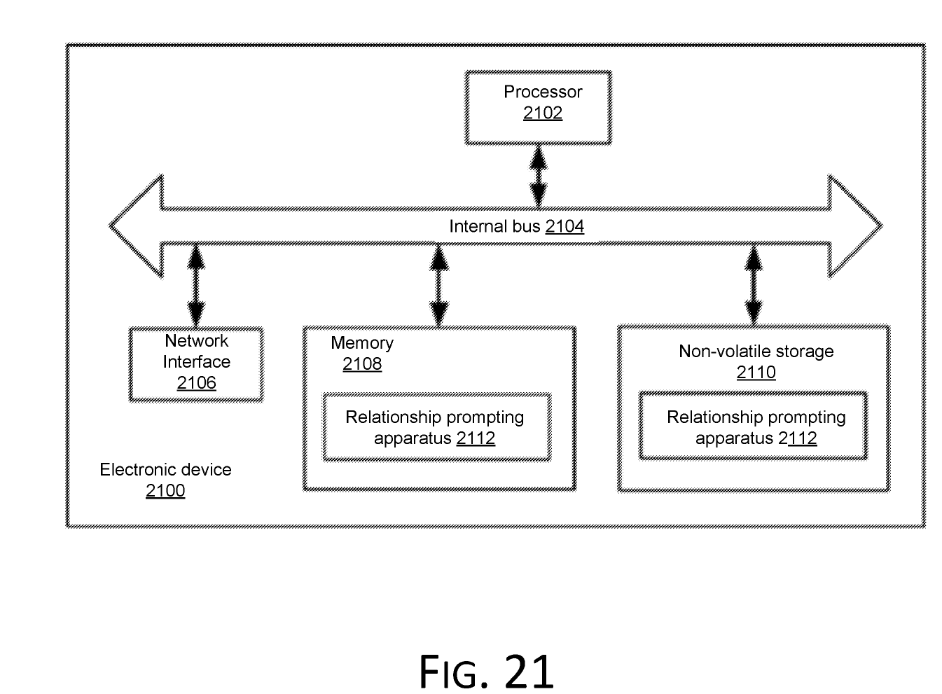

FIG. 21 is a schematic structural diagram of an electronic device according to an example embodiment of the present disclosure. Referring to FIG. 21, on the hardware level, the electronic device 2100 includes a processor 2102, an internal bus 2104, a network interface 2106, a memory 2108, and a non-volatile storage 2110, and certainly, may further include hardware required by other services. The processor 2102 reads a corresponding computer program from the non-volatile storage 2110 to the memory 2108 and runs the computer program, thereby forming a task prompting apparatus 2112 in a communication process on the logic level. Certainly, in addition to the software implementation, the present disclosure does not exclude other implementations, such as logic devices or a combination of software and hardware. In other words, entities executing the following processing process are not limited to various logic units, and may also be hardware or logic devices.

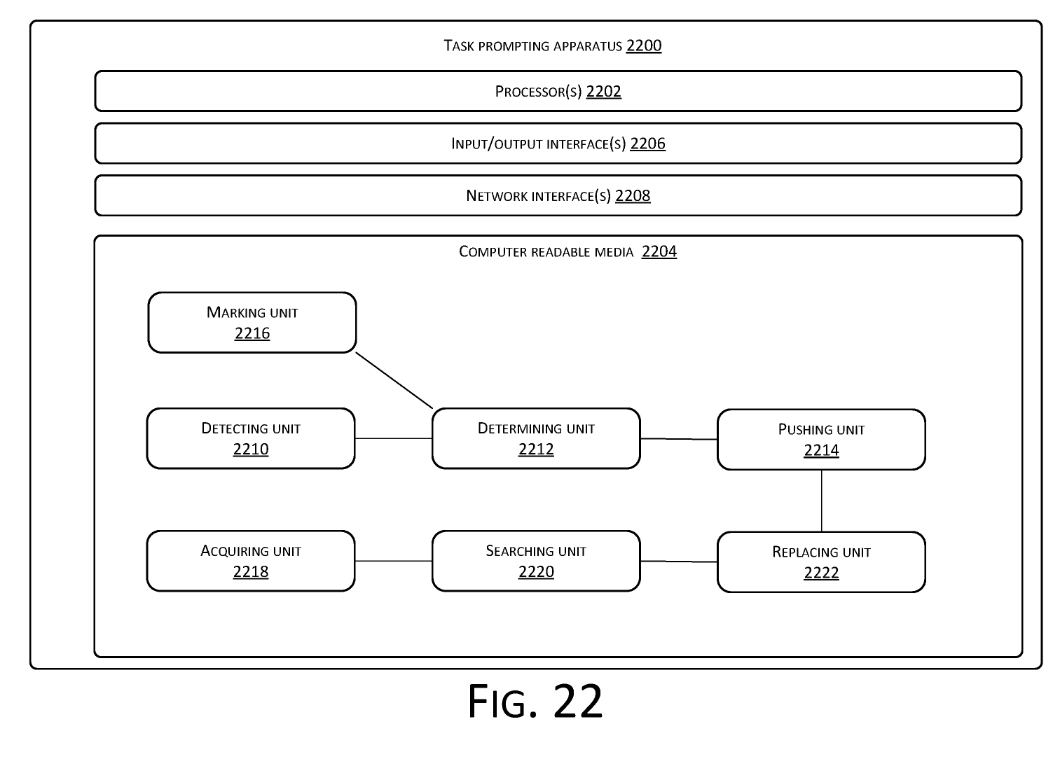

Referring to FIG. 22, in a software implementation, the task prompting apparatus 2200 includes one or more processor(s) 2202 or data processing unit(s) and computer readable media 2204. The task prompting apparatus 2200 may further include one or more input/output interface(s) 1206 and one or more network interface(s) 2208.

The computer readable media 2204 may store therein a plurality of modules or units including: a detecting unit 2210, a determining unit 2212, and a pushing unit 2214, wherein

the detecting unit 2210 is configured to detect a communication event;

the determining unit 2212 is configured to determine an uncompleted task related to a requester user and a responder user of the communication event; and

the pushing unit 2214 is configured to push the uncompleted task to at least one of the requester user and the responder user such that the completed task is displayed in an associated device of the corresponding user.

Optionally, the determining unit 2212 is specifically configured to:

determine the uncompleted task according to historical communication data between the requester user and the responder user.

Optionally, the historical communication data includes at least one of the following:

an instant messaging message, a call record, a telephone message, and an email.

Optionally, when the historical communication data is an instant messaging message, the uncompleted task is an instant messaging query request that is initiated by the requester user to the responder user and has not been answered yet;

when the historical communication data is a call record, the uncompleted task is a missed call record that is initiated by the requester user to the responder user and has not been processed yet;

when the historical communication data is a telephone message, the uncompleted task is telephone message content that is initiated by the requester user to the responder user and has not been processed yet; and

when the historical communication data is an email, the uncompleted task includes at least one of the following: email content having a preset importance degree and related to the requester user and the responder user, and an item that is discussed by the requester user and the responder user via an email and has not been completed yet.

Optionally, the determining unit 2212 is specifically configured to:

acquire a process service event related to the requester user and the responder user, and use an uncompleted process service event as the uncompleted task.

Optionally, the process service event includes at least one of the following: an examination and approval service event, a collaboration service event, and an attendance management event.

Optionally, the computer readable media 1204 may further store therein a marking unit 2216 configured to: when there are multiple uncompleted tasks, sort and mark the multiple uncompleted tasks according to importance degrees, such that the multiple uncompleted tasks are arranged and displayed in the associated device according to importance degrees.

Optionally, the associated device of the requester user is further configured to initiate the communication event, and the associated device of the responder user is further configured to respond to the communication event; or

the requester user initiates the communication event by using a first device different from the associated device of the requester user, and the responder user responds to the communication event by using a second device different from the associated device of the responder user.

Optionally, the communication event is a call event initiated to the responder user by the requester user using an instant messaging application.

Optionally, the communication event is an instant messaging event initiated to the responder user by the requester user using an instant messaging application.

Optionally, the instant messaging application is an enterprise instant messaging application.

Optionally, the computer readable media 1204 may further store therein:

an acquiring unit 2218 configured to acquire state information of the responder user;

a searching unit 2220 configured to search for a proxy user associated with the responder user when the state information indicates that the responder user is unable to process the uncompleted task; and

a replacing unit 2222 configured to replace the responder user of the communication event with the proxy user, and push the uncompleted task to the proxy user such that the uncompleted task is displayed in an associated device of the proxy user.

It should be noted that:

Pushing of the “relationship data” and pushing of the “uncompleted task” are described through different embodiments in the present disclosure. In fact, the “relationship data” and the “uncompleted task” may be pushed simultaneously. For example, when pushing the relationship data to the responder user, the server may further determine the uncompleted task related to the requester user and the responder user, or the uncompleted task related to the requester user and the associated user. Then, the server may push the uncompleted task to the responder user such that the uncompleted task is displayed in the associated device of the responder user.

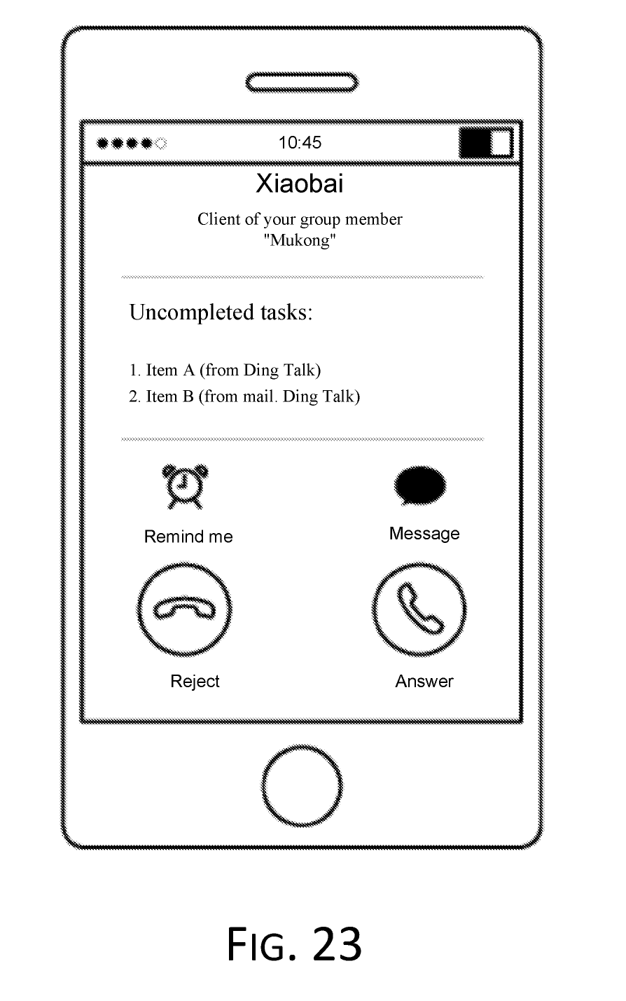

For example, the responder user “Xiaohei” implements responding to the communication event, displaying the relationship data, and prompting the uncompleted task respectively by using the same associated device. As shown in FIG. 23, when receiving a call request initiated by the user “Xiaobai”, the user “Xiaohei” may view from a call interface that relationship data is “Client of your group member ‘Mukong’”, and uncompleted tasks include “1. Project A”, “2. Project B”, and the like.

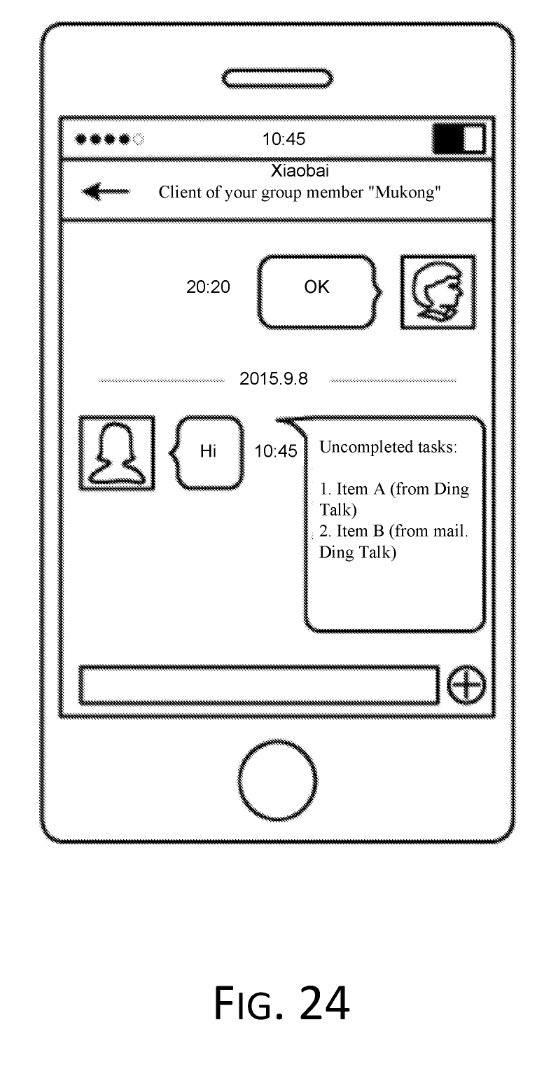

Moreover, as described above, there may be various types of communication events in the present disclosure, and further description is made below by using an “instant messaging”-type communication event as an example. As shown in FIG. 24, assume that the user “Xiaobai” is the initiator user, and the user “Xiaohei” is the responder user. FIG. 24 is a schematic diagram of an interface of an associated device of the user “Xiaohei”. When the user “Xiaobai” merely sends a greeting “Hi” to the user “Xiaohei”, the server on one hand recognizes that relationship data is “Client of your group member ‘Mukong’”, and on the other hand displays uncompleted tasks “1. Project A”, “2. Project B”, and the like. Therefore, the user “Xiaohei” may determine a communication intent of the user “Xiaobai” by viewing the relationship data and the uncompleted tasks without further description by the user “Xiaobai”, thus improving the efficiency of subsequent communication.

Certainly, similar to the displaying process of the relationship data, the solution of displaying the uncompleted task may also be applied to the communication solution shown in FIG. 10. For example, the user “Xiaohei” uses the mobile phone 404 to respond to the communication event, and uses an electronic device such as a mobile phone 3 or a computer to display the relationship data and the uncompleted task.

As may be seen from the above embodiments, the uncompleted task is pushed to and displayed on the associated device of the responder user; in combination with the relationship data pushed and displayed, the responder user may know identity information and the communication intent of the requester user in time and get prepared accordingly. The requester user does not need to describe and explain the uncompleted task, thus shortening the communication time and improving the communication efficiency.

In a typical configuration, a computer device includes one or more processors (CPUs), an input/output interface, a network interface, and a memory.

The memory may include a volatile memory, a random access memory (RAM) and/or a non-volatile memory or the like in a computer readable medium, for example, a read only memory (ROM) or a flash RAM. The memory is an example of the computer readable medium.

The computer readable medium includes non-volatile and volatile media as well as movable and non-movable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessed by the computing device. According to the definition of this text, the computer readable medium does not include transitory media, such as a modulated data signal and a carrier.

It should be further noted that the term “include”, “comprise” or other variations thereof are intended to cover non-exclusive including, so that a process, method, product or device including a series of elements not only includes the elements, but also includes other elements not clearly listed, or further includes inherent elements of the process, method, product or device. In a case without any more limitations, an element defined by “including a . . . ” does not exclude that the process, method, product or device including the element further has other identical elements.

The above descriptions are merely example embodiments of the present disclosure, and are not intended to limit the present disclosure. Any modification, equivalent replacement and improvement made without departing from the spirit and principle of the present disclosure shall fall within the protection scope of the present disclosure.

The present disclosure may further be understood with clauses as follows.

Clause 1. A relationship prompting method in a communication process, comprising:

detecting a communication event;

determining relationship data between a requester user and a responder user or an associated user corresponding to the responder user of the communication event; and pushing the relationship data to the responder user such that the relationship data is displayed in an associated device of the responder user.

Clause 2. The method of clause 1, wherein any user belonging to the same group as the responder user is determined as the associated user.

Clause 3. The method of clause 2, wherein the any user is determined as belonging to the same group as the responder user when the any user and the responder user belong to the same enterprise or belong to the same department of the same enterprise.

Clause 4. The method of clause 2, wherein any user is determined as the associated user when the any user and the responder user belong to the same group and there is an uncompleted task related to the requester user and the any user.

Clause 5. The method of clause 1, wherein the step of determining relationship data between a requester user and a responder user or an associated user corresponding to the responder user of the communication event comprises:

determining relationship data between the requester user and the responder user or the associated user according to a pre-configured user relationship data set.

Clause 6. The method of clause 5, wherein when the requester user and the responder user belong to the same group, the user relationship data set comprises: organizational structure information of the group.

Clause 7. The method of clause 1, wherein the step of determining relationship data between a requester user and a responder user or an associated user corresponding to the responder user of the communication event comprises:

determining the relationship data according to historical communication data between the requester user and the responder user or the associated user.

Clause 8. The method of clause 1, further comprising:

when there are multiple pieces of relationship data, sorting and marking the multiple pieces of relationship data according to importance degrees, such that the multiple pieces of relationship data are arranged and displayed in a corresponding device according to importance degrees.

Clause 9. The method of clause 1, wherein

the associated device of the responder user is further configured to respond to the communication event; or

the responder user responds to the communication event by using a preset device different from the associated device of the responder user.

Clause 10. The method of clause 1, wherein the communication event is a call event initiated to the responder user by the requester user using an instant messaging application.

Clause 11. The method of clause 1, wherein the communication event is an instant messaging event initiated to the responder user by the requester user using an instant messaging application.

Clause 12. The method of clause 10 or 11, wherein the instant messaging application is an enterprise instant messaging application.

Clause 13. The method of clause 1, further comprising:

acquiring state information of the responder user;

searching for a proxy user associated with the responder user when the state information indicates that the responder user is unable to respond to the communication event; and

replacing the responder user of the communication event with the proxy user, and pushing the relationship data to the proxy user such that the relationship data is displayed in an associated device of the proxy user.

Clause 14. The method of clause 1, further comprising:

invoking server-side synchronous data of a local user relationship data set of the responder user; and

canceling the operation of pushing the relationship data to the responder user when the server-side synchronous data comprises pre-stored data matching the relationship data.

Clause 15. A relationship prompting apparatus in a communication process, comprising:

a detecting unit configured to detect a communication event;

a determining unit configured to determine relationship data between a requester user and a responder user or an associated user corresponding to the responder user of the communication event; and

a prompting unit configured to push the relationship data to the responder user such that the relationship data is displayed in an associated device of the responder user.

Clause 16. The apparatus of clause 15, wherein the determining unit is specifically configured to:

determine the relationship data between the requester user and the responder user or the associated user according to a pre-configured user relationship data set.

Clause 17. The apparatus of clause 15, wherein the determining unit is specifically configured to:

determine the relationship data according to historical communication data between the requester user and the responder user or the associated user.

Clause 18. The apparatus of clause 15, wherein

the associated device of the responder user is further configured to respond to the communication event; or

the responder user responds to the communication event by using a preset device different from the associated device of the responder user.

Clause 19. The apparatus of clause 15, further comprising:

an acquiring unit configured to acquire state information of the responder user;

a searching unit configured to search for a proxy user associated with the responder user when the state information indicates that the responder user is unable to respond to the communication event; and

a replacing unit configured to replace the responder user of the communication event with the proxy user and push the relationship data to the proxy user such that the relationship data is displayed in an associated device of the proxy user.

Clause 20. The apparatus of clause 15, further comprising:

an invoking unit configured to invoke server-side synchronous data of a local user relationship data set of the responder user; and

a canceling unit configured to cancel the operation of pushing the relationship data to the responder user when the server-side synchronous data comprises pre-stored data matching the relationship data.

Clause 21. A task prompting method in a communication process, comprising:

detecting a communication event;

determining an uncompleted task related to a requester user and a responder user of the communication event; and

pushing the uncompleted task to at least one of the requester user and the responder user such that the uncompleted task is displayed in an associated device of the corresponding user.

Clause 22. The method of clause 21, wherein the step of determining an uncompleted task related to a requester user and a responder user of the communication event comprises:

determining the uncompleted task according to historical communication data between the requester user and the responder user.

Clause 23. The method of clause 22, wherein the historical communication data comprises at least one of the following:

an instant messaging message, a call record, a telephone message, and an email.

Clause 24. The method of clause 23, wherein

when the historical communication data is an instant messaging message, the uncompleted task is an instant messaging query request that is initiated by the requester user to the responder user and has not been answered yet;

when the historical communication data is a call record, the uncompleted task is a missed call record that is initiated by the requester user to the responder user and has not been processed yet;

when the historical communication data is a telephone message, the uncompleted task is telephone message content that is initiated by the requester user to the responder user and has not been processed yet; and

when the historical communication data is an email, the uncompleted task comprises at least one of the following: email content having a preset importance degree and related to the requester user and the responder user, and an item that is discussed by the requester user and the responder user via an email and has not been completed yet.

Clause 25. The method of clause 21, wherein the step of determining an uncompleted task related to a requester user and a responder user of the communication event comprises:

acquiring a process service event related to the requester user and the responder user, and using an uncompleted process service event as the uncompleted task.

Clause 26. The method of clause 25, wherein the process service event comprises at least one of the following: an examination and approval service event, a collaboration service event, and an attendance management event.

Clause 27. The method of clause 21, further comprising:

when there are multiple uncompleted tasks, sorting and marking the multiple uncompleted tasks according to importance degrees, such that the multiple uncompleted tasks are arranged and displayed in the associated device according to importance degrees.

Clause 28. The method of clause 21, wherein

the associated device of the requester user is further configured to initiate the communication event, and the associated device of the responder user is further configured to respond to the communication event; or

the requester user initiates the communication event by using a first device different from the associated device of the requester user, and the responder user responds to the communication event by using a second device different from the associated device of the responder user.

Clause 29. The method of clause 21, wherein the communication event is a call event initiated to the responder user by the requester user using an instant messaging application.

Clause 30. The method of clause 21, wherein the communication event is an instant messaging event initiated to the responder user by the requester user using an instant messaging application.

Clause 31. The method of clause 29 or 30, wherein the instant messaging application is an enterprise instant messaging application.

Clause 32. The method of clause 21, further comprising:

acquiring state information of the responder user;

searching for a proxy user associated with the responder user when the state information indicates that the responder user is unable to process the uncompleted task; and

replacing the responder user of the communication event with the proxy user, and pushing the uncompleted task to the proxy user such that the uncompleted task is displayed in an associated device of the proxy user.

Clause 33. A task prompting apparatus in a communication process, comprising:

a detecting unit configured to detect a communication event;

a determining unit configured to determine an uncompleted task related to a requester user and a responder user of the communication event; and

a pushing unit configured to push the uncompleted task to at least one of the requester user and the responder user such that the uncompleted task is displayed in an associated device of the corresponding user.

Clause 34. The apparatus of clause 33, wherein the determining unit is specifically configured to:

determine the uncompleted task according to historical communication data between the requester user and the responder user.

Clause 35. The apparatus of clause 33, wherein the determining unit is specifically configured to:

acquire a process service event related to the requester user and the responder user, and use an uncompleted process service event as the uncompleted task.

Clause 36. The apparatus of clause 33, further comprising:

a marking unit configured to: when there are multiple uncompleted tasks, sort and mark the multiple uncompleted tasks according to importance degrees, such that the multiple uncompleted tasks are arranged and displayed in the associated device according to importance degrees.

Clause 37. The apparatus of clause 33, further comprising:

an acquiring unit configured to acquire state information of the responder user;

a searching unit configured to search for a proxy user associated with the responder user when the state information indicates that the responder user is unable to process the uncompleted task; and

a replacing unit configured to replace the responder user of the communication event with the proxy user, and push the uncompleted task to the proxy user such that the uncompleted task is displayed in an associated device of the proxy user.

What is claimed is:

1. A method comprising:
detecting a communication event;
determining relationship data between a requester user and a responder user or an associated user corresponding to the responder user of the communication event; and
pushing the relationship data to the responder user such that the relationship data is displayed in an associated device of the responder user.

2. The method of claim 1, further comprising determining a user as the associated user.

3. The method of claim 2, wherein the determining the user as the associated user includes:
determining that the user and the responder user belong to a same group, the same group including a same enterprise or a same department of the same enterprise.

4. The method of claim 2, wherein the determining the user as the associated user includes:
determining that the user and the responder user belong to a same group and there is an uncompleted task related to the requester user and the user.

5. The method of claim 1, wherein the determining the relationship data between the requester user and the responder user or the associated user corresponding to the responder user of the communication event includes:
determining the relationship data between the requester user and the responder user or the associated user according to a pre-configured user relationship data set.

6. The method of claim 5, further comprising:
determining that the requester user and the responder user belong to a same group; and
obtaining organizational structure information of the group.

7. The method of claim 1, wherein the determining the relationship data between the requester user and the responder user or the associated user corresponding to the responder user of the communication event includes:
determining the relationship data according to historical communication data between the requester user and the responder user or the associated user.

8. The method of claim 1, further comprising:
sorting and marking multiple pieces of relationship data according to importance degrees, such that the multiple pieces of relationship data are arranged and displayed in a corresponding device according to importance degrees.

9. The method of claim 1, wherein the communication event is a call event initiated to the responder user by the requester user.

10. The method of claim 1, wherein the communication event is an instant messaging event initiated to the responder user by the requester user using an instant messaging application.

11. The method of claim 1, further comprising:
acquiring state information of the responder user;
searching for a proxy user associated with the responder user when the state information indicates that the responder user is unable to respond to the communication event;
replacing the responder user of the communication event with the proxy user; and
pushing the relationship data to the proxy user for display.

12. The method of claim 1, further comprising:
invoking server-side synchronous data of a local user relationship data set of the responder user;
determining that the server-side synchronous data includes pre-stored data matching the relationship data; and
canceling an operation of pushing the relationship data to the responder user

13. A method comprising:
detecting a communication event;
determining an uncompleted task related to a requester user and a responder user of the communication event; and
pushing the uncompleted task to at least one of the requester user and the responder user for display.

14. The method of claim 13, wherein the determining the uncompleted task related to the requester user and the responder user of the communication event comprises:
determining the uncompleted task according to historical communication data between the requester user and the responder user.

15. The method of claim 14, wherein:
the historical communication data includes an instant messaging message; and
the uncompleted task includes an instant messaging query request that is initiated by the requester user to the responder user and has not been answered.

16. The method of claim 14, wherein:
the historical communication data includes a call record; and
the uncompleted task includes is a missed call record that is initiated by the requester user to the responder user and has not been processed.

17. The method of claim 14, wherein:
the historical communication data includes a telephone message; and
the uncompleted task includes a telephone message content that is initiated by the requester user to the responder user and has not been processed.

18. The method of claim 14, wherein:
the historical communication data includes an email; and
the uncompleted task includes an email content having a preset importance degree and related to the requester user and the responder user, or an item that is discussed by the requester user and the responder user via an email and has not been completed.

19. The method of claim 13, further comprising:
acquiring state information of the responder user;
determining that the state information indicates that the responder user is unable to process the uncompleted task searching for a proxy user associated with the responder user;
replacing the responder user of the communication event with the proxy user; and
pushing the uncompleted task to the proxy user for display.

20. An apparatus comprising:
one or more processors; and
one or more computer readable storing thereon computer-readable instructions that, when executed by the one or more processors, cause the one or more processors to perform acts comprising:
detecting a communication event;
determining relationship data between a requester user and an associated user corresponding to a responder user of the communication event; and
pushing the relationship data to the responder user such that the relationship data is displayed in an associated device of the responder user.
